(19) United States
(12) Patent Application Publication
(10) Pub. No.: US 2026/0292159 A1
(43) Pub. Date: Sep. 24, 2026

(54) NEURAL NETWORK (NN) POST-FILTERING

(71) Applicant: Telefonaktiebolaget LM Ericsson (publ), Stockholm (SE)

(72) Inventors: Martin PETTERSSON, Vallentuna (SE); Mitra DAMGHANIAN, Upplands-Bro (SE); Rickard SJÖBERG, Stockholm (SE)

(73) Assignee: Telefonaktiebolaget LM Ericsson (publ), Stockholm (SE)

(21) Appl. No.: 19/474,463

(22) PCT Filed: Apr. 11, 2024
(86) PCT No.: PCT/EP2024/059919

§ 371 Date: Oct. 10, 2025

Related U.S. Application Data
(60) Provisional application No. 63/458,804, filed on Apr. 12, 2023.

(51) Int. Cl. H04N 19/117; H04N 19/172; H04N 19/70; H04N 19/85

(52) U.S. Cl. CPC H04N 19/117; H04N 19/172; H04N 19/70; H04N 19/85

(57) ABSTRACT

A method for post-processing a decoded picture. The method includes receiving a bitstream and using information encoded in the bitstream (e.g., encoded sample values) to produce the decoded picture. The method also includes obtaining a first set of parameters, the first set of parameters comprising neural network, NN, parameters specifying a NN post-filter, NNPF, having one or more purposes. The method also includes decoding a first indicator value from a first syntax element in the bitstream, the first indicator value indicating the purposes of the NNPF. The one or more purposes include: colour range conversion (including SDR to HDR conversion), deinterlacing, alpha map generation, depth image generation, generation of new views (view synthesis), inpainting (subtitle removal, object removal, etc.), focus and blur, retexturing, restyling (or style transfer), and/or film grain synthesis.

### TECHNICAL FIELD

Disclosed are embodiments related to image processing using a neural network (NN) post-filter.

### BACKGROUND

### Versatile Video Coding (VVC)

Versatile Video Coding (VVC) and its predecessor, High Efficiency Video Coding (HEVC), are block-based video codecs standardized and developed jointly by ITU-T and MPEG. The codecs utilize both temporal and spatial prediction. VVC and HEVC are similar in many aspects. Spatial prediction is achieved using intra (I) prediction from within a current picture (i.e., the picture currently being decoded). Temporal prediction is achieved using uni-directional (P) or bi-directional inter (B) prediction on the block level from previously decoded reference pictures.

In the encoder, the difference between the original pixel data and the predicted pixel data, referred to as the residual, is transformed into the frequency domain, quantized and then entropy coded before transmitted together with necessary prediction parameters such as prediction mode and motion vectors, also entropy coded. The decoder performs entropy decoding, inverse quantization, and inverse transformation to obtain the residual, and then adds the residual to an intra or inter prediction to reconstruct a picture.

The VVC version 1 specification was published as Rec. ITU-T H.266|ISO/IEC 23090-3, “Versatile Video Coding,” in 2020 and version 2 with support for higher bit depths was published in 2022. MPEG and ITU-T are working together within the Joint Video Exploratory Team (JVET) on updated versions of HEVC and VVC as well as the successor to VVC, i.e., the next generation video codec.

### Components

A video sequence consists of a series of pictures where each picture consists of one or more components. A picture in a video sequence is sometimes denoted ‘image’ or ‘frame’. Each component in a picture can be described as a two-dimensional rectangular array of sample values (or “samples” for short). It is common that a picture in a video sequence consists of three components; one luma component Y where the sample values are luma values and two chroma components Cb and Cr, where the sample values are chroma values. Other common representations include ICtCb, IPT, constant-luminance YCbCr, YCoCg and others. It is also common that the dimensions of the chroma components are smaller than the luma components by a factor of two in each dimension. For example, the size of the luma component of an HD picture would be 1920×1080 and the chroma components would each have the dimension of 960×540. Components are sometimes referred to as ‘color components’, and other times as ‘channels’.

### Blocks and Units

In many video coding standards, such as HEVC and VVC, each component of a picture is split into blocks and the coded video bitstream consists of a series of coded blocks. A block is a two-dimensional array of sample values. It is common in video coding that the picture is split into units that cover a specific area of the picture. Each unit consists of all blocks from all components that make up that specific area and each block belongs fully to one unit. The macroblock in H.264 and the Coding unit (CU) in HEVC and VVC are examples of units.

A transform used in coding may be applied to a block to produce a transform blocks. A prediction block is formed by applying a prediction mode to a block.

### VVC Block Structure

The VVC video coding standard uses a block structure referred to as quadtree plus binary tree plus ternary tree block structure (QTBT+TT) where each picture is first partitioned into square blocks called coding tree units (CTU). The size of all CTUs are identical and the partition is done without any syntax controlling it. Each CTU is further partitioned into coding units (CU) that can have either square or rectangular shapes. The CTU is first partitioned by a quad tree structure, then it may be further partitioned with equally sized partitions either vertically or horizontally in a binary structure to form coding units (CUs). A block could thus have either a square or rectangular shape. The depth of the quad tree and binary tree can be set by the encoder in the bitstream. The ternary tree (TT) part adds the possibility to divide a CU into three partitions instead of two equally sized partitions; this increases the possibilities to use a block structure that better fits the content structure in a picture.

### NAL Units

Both VVC and HEVC define a Network Abstraction Layer (NAL). All the data, i.e. both Video Coding Layer (VCL) or non-VCL data in HEVC and VVC is encapsulated in NAL units. A VCL NAL unit contains data that represents picture sample values. A non-VCL NAL unit contains additional associated data such as parameter sets and supplemental enhancement information (SEI) messages. The NAL unit in VVC and HEVC begins with a header called the NAL unit header. The syntax for the NAL unit header for HEVC starts with a forbidden_zero_bit that shall always be equal to 0 to prevent start code emulations. Without it, some MPEG systems might confuse the HEVC video bitstream with other data, but the 0 bit in the NAL unit header makes all possible HEVC bitstreams uniquely identifiable as HEVC bitstreams. The NAL unit header in VVC is very similar to the one in HEVC but uses 1 bit less for the nal_unit_type and instead reserves this bit for future use. The nal_unit_type, nuh_layer_id and nuh_temporal_id_plus1 code words specify the NAL unit type of the NAL unit that identifies what type of data is carried in the NAL unit, the scalability layer ID and the temporal layer ID to which the NAL unit belongs. The NAL unit type indicates and specifies how the NAL unit should be parsed and decoded. The rest of the bytes of the NAL unit is payload of the type indicated by the NAL unit type. A bitstream consists of a series of concatenated NAL units.

A decoder or bitstream parser can conclude how the NAL unit should be handled, e.g., parsed and decoded, after looking at the NAL unit header. The rest of the bytes of the NAL unit is payload of the type indicated by the NAL unit type. All VVC or HEVC bitstreams consist of a series of concatenated NAL units.

The decoding order is the order in which NAL units shall be decoded, which is the same as the order of the NAL units within the bitstream. The decoding order may be different from the output order, which is the order in which decoded pictures are to be output, such as for display, by the decoder.

### Layers and Scalability

The value of the nuh_layer_id syntax element in the NAL unit header specifies the layer ID to which the NAL unit belongs.

A layer access unit in VVC is defined as a set of NAL units for which the VCL NAL units all have a particular value of nuh_layer_id, that are associated with each other according to a specified classification rule, that are consecutive in decoding order, and that contain exactly one coded picture.

A coded layer video sequence (CLVS) in VVC is defined as a sequence of layer access units that consists, in decoding order, of a CLVS layer access unit, followed by zero or more layer access units that are not CLVS layer access units, including all subsequent layer access units up to but not including any subsequent layer access unit that is a CLVS layer access unit.

In VVC, layers may be coded independently or dependently from each other. When the layers are coded independently, a layer with e.g. nuh_layer_id 0 may not predict video data from another layer with e.g. nuh_layer_id 1. In VVC, dependent coding between layers may be used, which enables support for scalable coding with SNR, spatial and view scalability.

Intra random access point (IRAP) pictures and the coded video sequence (CVS)

For single scalability layer coding in HEVC, an access unit (AU) is the coded representation of a single picture. An AU may consist of several video coding layer (VCL) NAL units as well as non-VCL NAL units.

An intra random access point (IRAP) picture in HEVC is a picture that does not refer to any pictures other than itself for prediction in its decoding process. The first picture in the bitstream in decoding order in HEVC must be an IRAP picture but an IRAP picture may additionally also appear later in the bitstream. HEVC specifies three types of

IRAP pictures, the broken link access (BLA) picture, the instantaneous decoder refresh (IDR) picture and the clean random access (CRA) picture.

A coded video sequence (CVS) in HEVC is a sequence of access units starting at an IRAP access unit followed by zero or more AUs up to, but not including the next IRAP access unit in decoding order.

In VVC, a CVS is a sequence of access units starting at a CVS start (CVSS) access unit followed by zero or more AUs up to, but not including the next CVSS access unit in decoding order. A CVSS access unit may contain an IRAP picture, i.e., an IDR or a CRA picture, or a gradual decoding refresh (GDR) picture. A CVS may contain one or more coded layer video sequences (CLVSs).

### Slices and Tiles

The concept of slices in HEVC divides the picture into independently coded slices, where decoding of one slice in a picture is independent of other slices of the same picture. Different coding types could be used for slices of the same picture, i.e. a slice could either be an I-slice, P-slice or B-slice. One purpose of slices is to enable resynchronization in case of data loss. In HEVC, a slice is a set of CTUs.

The VVC and HEVC video coding standards includes a tool called tiles that divides a picture into rectangular spatially independent regions. Tiles in VVC are similar to the tiles used in HEVC. Using tiles, a picture in VVC can be partitioned into rows and columns of CTUs where a tile is an intersection of a row and a column.

In VVC, a slice is defined as an integer number of complete tiles or an integer number of consecutive complete CTU rows within a tile of a picture that are exclusively contained in a single NAL unit. In VVC, a picture may be partitioned into either raster scan slices or rectangular slices. A raster scan slice consists of a number of complete tiles in raster scan order. A rectangular slice consists of a group of tiles that together occupy a rectangular region in the picture or a consecutive number of CTU rows inside one tile. Each slice has a slice header comprising syntax elements. Decoded slice header values from these syntax elements are used when decoding the slice. Each slice is carried in one VCL NAL unit. In an early draft of the VVC specification, slices were referred to as tile groups.

### Subpictures

Subpictures are supported in VVC where a subpicture is defined as a rectangular region of one or more slices within a picture. This means a subpicture contains one or more slices that collectively cover a rectangular region of a picture. In the VVC specification subpicture location and size are signaled in the SPS. Boundaries of a subpicture region may be treated as picture boundaries (excluding in-loop filtering operations) conditioned to a per-subpicture flag subpic_treated_as_pic_flag[i] in the SPS. Also loop-filtering on subpicture boundaries is conditioned to a per-subpicture flag loop_filter_across_subpic_enabled_flag[i] in the SPS.

Bitstream extraction and merge operations are supported through subpictures in VVC and could for instance comprise extracting one or more subpictures from a first bitstream, extracting one or more subpictures from a second bitstream and merging the extracted subpictures into a new third bitstream.

### Picture Order Count (POC)

Pictures in HEVC are identified by their picture order count (POC) values, also known as full POC values. Each slice contains a code word, pic_order_cnt_lsb, that shall be the same for all slices in a picture. pic_order_cnt_lsb is also known as the least significant bits (lsb) of the full POC since it is a fixed-length code word and only the least significant bits of the full POC is signaled. Both encoder and decoder keep track of POC and assign POC values to each picture that is encoded/decoded. The pic_order_cnt_lsb can be signaled by 4-16 bits. There is a variable MaxPicOrderCntLsb used in HEVC which is set to the maximum pic_order_cnt_lsb value plus 1. This means that if 8 bits are used to signal pic_order_cnt_lsb, the maximum value is 255 and MaxPicOrderCntLsb is set to 2\hat{ }8=256. The picture order count value of a picture is called PicOrderCntVal in HEVC. Usually, PicOrderCntVal for the current picture is simply called PicOrderCntVal.

### Reference Picture Management

Reference picture management in HEVC is done using reference pictures sets (RPS). The reference picture set is a set of reference pictures that is signaled in the slice headers. When the decoder has decoded a picture, it is put together with its POC value in a decoded picture buffer (DPB). When decoding a subsequence picture, the decoder parses the RPS syntax from the slice header and constructs lists of reference picture POC values.

The reference picture management in the VVC specification differ slightly from the one in HEVC. In HEVC, the RPS is signaled and the reference picture lists to use for Inter prediction is derived from the RPS. In the VVC specification, the reference pictures lists (RPL) are signaled and the RPS is derived. However, in both specifications, signaling of what pictures to keep in the DPB, what pictures should be short-term and long-term is done. Using POC for picture identification and determination of missing reference pictures is done the same in both specifications.

### Parameter Sets

HEVC and VVC specifies three types of parameter sets, the picture parameter set (PPS), the sequence parameter set (SPS) and the video parameter set (VPS). The PPS contains data that is common for a whole picture, the SPS contains data that is common for a coded video sequence (CVS) and the VPS contains data that is common for multiple CVSs, e.g. data for multiple scalability layers in the bitstream.

VVC also specifies one additional parameter set, the adaptation parameter set (APS). The APS carries parameters needed for the adaptive loop filter (ALF) tool, the luma mapping and chroma scaling (LMCS) tool and the scaling list tool.

Both HEVC and VVC allow certain information (e.g. parameter sets) to be provided by external means. “By external means” should be interpreted as the information is not provided in the coded video bitstream but by some other means not specified in the video codec specification, e.g. via metadata possibly provided in a different data channel, as a constant in the decoder, or provided through an API to the decoder.

### Decoding Capability Information (DCI)

In VVC there is a DCI NAL unit. The DCI specifies information that don't change during the decoding session and may be good for the decoder to know about early and upfront, such as profile and level information. The information in the DCI is not necessary for operation of the decoding process. In drafts of the VVC specification the DCI was called decoding parameter set (DPS).

The decoding capability information may also contain a set of general constraints for the bitstream, that gives the decoder information of what to expect from the bitstream, in terms of coding tools, types of NAL units, etc. In VVC, the general constraint information can be signaled in the DCI, VPS or SPS.

### Picture Header

In VVC, a coded picture contains a picture header structure. The picture header structure contains syntax elements that are common for all slices of the associated picture. The picture header structure may be signaled in its own non-VCL NAL unit with NAL unit type PH_NUT or included in the slice header given that there is only one slice in the coded picture. This is indicated by the slice header syntax element picture_header_in_slice_header_flag, where a value equal to 1 specifies that the picture header structure is included in the slice header and a value equal to 0 specifies that the picture header structure is carried in its own PH NAL unit. For a CVS where not all pictures are single-slice pictures, each coded picture must be preceded by a picture header that is signaled in its own NAL unit. HEVC does not support picture headers.

### SEI Messages

Supplementary Enhancement Information (SEI) messages are codepoints in the coded bitstream that do not influence the decoding process of coded pictures from VCL NAL units. SEI messages usually address issues of representation/rendering of the decoded bitstream. The overall concept of SEI messages and many of the messages themselves have been inherited from the H.264 and HEVC specifications into the VVC specification. In VVC, an SEI RBSP contains one or more SEI messages.

SEI messages assist in processes related to decoding, display or other purposes. However, SEI messages are not required for constructing the luma or chroma samples by the decoding process. Some SEI messages are required for checking bitstream conformance and for output timing decoder conformance. Other SEI messages are not required for checking bitstream conformance. A decoder is not required to support all SEI messages. Usually, if a decoder encounters an unsupported SEI message, it is discarded.

ITU-T H.274|ISO/IEC 23002-7, also referred to as VSEI, specifies the syntax and semantics of VUI parameters and SEI messages and is particularly intended for use with VVC, although it is written in a manner intended to be sufficiently generic that it may also be used with other types of coded video bitstreams. The first version of ITU-T H.274|ISO/IEC 23002-7 was finalized in July 2020. At the time of writing, version 3 is under development, which is expected to include several new SEI messages. The latest draft of VSEI version 3 is JVET-AC2032-v2 (“JVET-AC2032”).

### Video Usability Information (VUI)

The Video Usability Information (VUI) is a syntax structure sent in the SPS in VVC and HEVC. In HEVC it may additionally be carried in the VPS. The syntax and semantics of the VUI is specified in VSEI, with additional details for some of the parameters referenced from ITU-T H.273-“Coding independent code points for video signal type identification”

VUI carries information that does not affect the decoding process but may be essential for properly interpreting the decoded pictures. For instance, the VUI may specify whether the decoded pictures are progressive or interlaced, what the intended aspect ratio is, colour sample location information, and a colour description of the decoded pictures.

The colour description comprises information on the colour primaries, transfer characteristics and matrix coefficients of the intended display of the decoded pictures. In addition, it has a flag for indicating whether full range is used or not.

These parameters are used to specify the color gamut and color range intended for display, including how to properly display standard dynamic range (SDR) content such as specified by ITU-T BT.709 and ITU-T BT.2020 and high dynamic range (HDR) content such as specified by ITU-T BT.2100. Dynamic range is simply the range of the lightest tones to the darkest tones within a photo where HDR is a dynamic range higher than usual.

The colour primaries indicates the chromaticity x and y coordinates of the source colour primaries (green, blue, red, white).

The transfer characteristics indicates the direct or reverse reference opto-electronic transfer characteristic function of the source picture as a function of a source input linear optical intensity input with a nominal real-valued range of 0 to 1. With other words, the transfer characteristics is a function for mapping the decoded sample values to pixel values for display.

The matrix coefficients are used in deriving luma and chroma signals from the green, blue and red or X, Y and Z primaries.

The syntax structure of the VUI in VSEI is shown Table 1 below.

TABLE 1

| vui_parameters( payloadSize ) { | Descriptor |
|---|---|
| vui_progressive_source_flag | u(1) |
| vui_interlaced_source_flag | u(1) |
| vui_non_packed_constraint_flag | u(1) |
| vui_non_projected_constraint_flag | u(1) |
| vui_aspect_ratio_info_present_flag | u(1) |
| if( vui_aspect_ratio_info_present_flag ) { | |
| vui_aspect_ratio_constant_flag | u(1) |
| vui_aspect_ratio_idc | u(8) |
| if( vui_aspect_ratio_idc == 255 ) { | |
| vui_sar_width | u(16) |
| vui_sar_height | u(16) |
| } | |
| } | |
| vui_overscan_info_present_flag | u(1) |
| if( vui_overscan_info_present_flag ) | |
| vui_overscan_appropriate_flag | u(1) |
| vui_colour_description_present_flag | u(1) |
| if( vui_colour_description_present_flag ) { | |
| vui_colour_primaries | u(8) |
| vui_transfer_characteristics | u(8) |
| vui_matrix_coeffs | u(8) |
| vui_full_range_flag | u(1) |
| } | |
| vui_chroma_loc_info_present_flag | u(1) |
| if( vui_chroma loc_info_present_flag ) { | |
| if( vui_progressive_source_flag && | |
| !vui_interlaced_source_flag ) | |
| vui_chroma_sample_loc_type_frame | ue(v) |
| else { | |
| vui_chroma_sample_loc_type_top_field | ue(v) |
| vui_chroma_sample_loc_type_bottom_field | ue(v) |
| } | |
| } | |
| } | |

### NN Post-Filter (NNPF) Characteristics SEI Message

One of the new SEI messages expected in VSEI v3 is the neural network (NN) post-filter characteristics (NNPFC) SEI message. The NNPFC SEI message specifies an NN that may be used as a post-processing filter (hereafter called an “NN post-processing filter” or simply “NN post-filter” for short). The NN parameters, i.e., the weights of the NN, may be carried with the NNPFC SEI message. Alternatively, the NNPFC SEI message includes a URI for identifying the NN. The NNPFC SEI message also includes parameters for describing the characteristics of the NN, including information about the input to the NN, output from the NN and the purpose of the NN post-filter (NNPF).

In JVET-AC2032-v2 the NNPFC SEI message comprises the following purposes for the NNPF: General visual quality; Chroma upsampling; Resolution upsampling; Picture rate (frame rate) upsampling; Bit depth upsampling; and Colourization

The syntax of the NNPFC SEI message is shown in Table 2 below with the semantics relevant for this disclosure described.

TABLE 2

| nn_post_filter_characteristics( payloadSize ) { | Descriptor |
|---|---|
| nnpfc_purpose | u(16) |
| nnpfc_id | ue(v) |
| nnpfc_mode_idc | ue(v) |
| ... | |
| nnpfc_property_present_flag | u(1) |
| if( nnpfc_property_present_flag ) { | |
| ... | |
| nnpfc_num_input_pics_minus1 | ue(v) |
| if( ( nnpfc_purpose & 0x02 ) != 0 ) | |
| nnpfc_out_sub_c_flag | u(1) |
| if( ( nnpfc_purpose & 0x20 ) != 0 ) | |
| nnpfc_out_colour_format_idc | u(2) |
| if( ( nnpfc_purpose & 0x04 ) != 0 ) { | |
| nnpfc_pic_width_in_luma_samples | ue(v) |
| nnpfc_pic_height_in_luma_samples | ue(v) |
| } | |
| if( ( nnpfc_purpose & 0x08 ) != 0 ) { | |
| for( i = 0; i < nnpfc_num_input_pics_minus1; i++ ) | |
| nnpfc_interpolated_pics[ i ] | ue(v) |
| for( i = 0; i <= nnpfc_num_input_pics_minus1; i++ ) | |
| nnpfc_input_pic_output_flag[ i ] | u(1) |
| } | |
| ... | |
| nnpfc_separate_colour_description_present_flag | u(1) |
| if( nnpfc_separate_colour_description_present_flag ) { | |
| nnpfc_colour_primaries | u(8) |
| nnpfc_transfer_characteristics | u(8) |
| nnpfc_matrix_coeffs | u(8) |
| } | |
| ... | |
| } | |
| ... | |
| } | |

The syntax element nnpfc_purpose indicates the purpose of the NNPF. The interpretations of the values of nnpfc_purpose are shown in Table 3.

TABLE 3

| Value | Interpretation |
|---|---|
| nnpfc_purpose = = 0 | May be used as determined by the application |
| nnpfc_purpose > 0 && | No general visual quality improvement |
| ( nnpfc_purpose & | |
| 0x01 ) = = 0 | |
| ( nnpfc_purpose & | With general visual quality improvement |
| 0x01 ) != 0 | |
| nnpfc_purpose > 0 && | No chroma upsampling (from the 4:2:0 chroma format to the 4:2:2 |
| ( nnpfc_purpose & | or 4:4:4 chroma format, or from the 4:2:2 chroma format to the |
| 0x02 ) = = 0 | 4:4:4 chroma format) |
| ( nnpfc_purpose & | With chroma upsampling |
| 0x02 ) != 0 | |
| nnpfc_purpose > 0 && | No resolution upsampling (increasing the width or height) |
| ( nnpfc_purpose & | |
| 0x04 ) = = 0 | |
| ( nnpfc_purpose & | With resolution upsampling |
| 0x04 ) != 0 | |
| nnpfc_purpose > 0 && | No picture rate upsampling |
| ( nnpfc_purpose & | |
| 0x08 ) = = 0 | |
| ( nnpfc_purpose & | With picture rate upsampling |
| 0x08 ) != 0 | |
| nnpfc_purpose > 0 && | No bit depth upsampling (increasing the luma bit depth or the |
| ( nnpfc_purpose & | chroma bit depth) |
| 0x10 ) = = 0 | |
| ( nnpfc_purpose & | With bit depth upsampling |
| 0x10 ) != 0 | |
| nnpfc_purpose > 0 && | No colourization (from the 4:0:0 chroma format to the 4:2:0, 4:2:2, |
| ( nnpfc_purpose & | or 4:4:4 chroma format) |
| 0x20 ) = = 0 | |
| ( nnpfc_purpose & | With colourization |
| 0x20 ) != 0 | |

When a reserved value of nnpfc_purpose is taken into use in the future by ITU-T|ISO/IEC, the syntax of this SEI message could be extended with syntax elements whose presence is conditioned by nnpfc_purpose being equal to that value.

When ChromaFormatIdc is equal to 3, nnpfc_purpose & 0x02 shall be equal to 0.

When ChromaFormatIdc or nnpfc_purpose & 0x02 is not equal to 0, nnpfc_purpose & 0x20 shall be equal to 0.

nnpfc_pic_width_in_luma_samples and nnpfc_pic_height_in_luma_samples specify the width and height, respectively, of the luma sample array of the picture resulting from applying the NN post-filter (NNPF) identified by nnpfc_id to a cropped decoded output picture. When nnpfc_pic_width_in_luma_samples and nnpfc_pic_height_in_luma_samples are not present, they are inferred to be equal to CroppedWidth and CroppedHeight, respectively. The value of nnpfc_pic_width_in_luma_samples shall be in the range of CroppedWidth to CroppedWidth*16-1, inclusive. The value of nnpfc_pic_height_in_luma_samples shall be in the range of CroppedHeight to CroppedHeight*16-1, inclusive.

nnpfc_num_input_pics_minus1 plus 1 specifies the number of decoded output pictures used as input for the NNPF. The value of nnpfc_num_input_pics_minus1 shall be in the range of 0 to 63, inclusive. When nnpfc_purpose & 0x08 is not equal to 0, the value of nnpfc_num_input_pics_minus1 shall be greater than 0.

nnpfc_interpolated_pics[i] specifies the number of interpolated pictures generated by the NNPF between the i-th and the (i+1)-th picture used as input for the NNPF. The value of nnpfc_interpolated_pics[i] shall be in the range of 0 to 63, inclusive. The value of nnpfc_interpolated_pics[i] shall be greater than 0 for at least one i in the range of 0 to nnpfc_num_input_pics_minus1-1, inclusive.

nnpfc_input_pic_output_flag[i] equal to 1 indicates that for the i-th input picture the NNPF generates a corresponding output picture. nnpfc_input_pic_output_flag[i] equal to 0 indicates that for the i-th input picture the NNPF does not generate a corresponding output picture.

The variables numInputPics, specifying the number of pictures used as input for the NNPF, and numOutputPics, specifying the total number of pictures resulting from the NNPF, are derived as shown in Table 4:

TABLE 4

```
numInputPics = nnpfc_num_input pics_minus1 + 1
if( ( nnpfc_purpose & 0x08 ) != 0 ) {
            for( i = 0, numOutputPics = 0; i < numInputPics; i++ )
                        if( nnpfc_input_pic_output_flag[ i ] )
                                    numOutputPics++
            for( i = 0; i <= numInputPics − 2; i++ )
                        numOutputPics += nnpfc_interpolated_pics[ i ]
} else
            numOutputPics = 1
```

nnpfc_separate_colour_description_present_flag equal to 1 indicates that a distinct combination of colour primaries, transfer characteristics, and matrix coefficients for the picture resulting from the NNPF is specified in the SEI message syntax structure. nnpfc_separate_colour_description_present_flag equal to 0 indicates that the combination of colour primaries, transfer characteristics, and matrix coefficients for the picture resulting from the NNPF is the same as indicated in VUI parameters for the CLVS.

nnpfc_colour_primaries has the same semantics as specified in JVET-AC2032 subclause 7.3 for the vui_colour_primaries syntax element, except as follows:
nnpfc_colour_primaries specifies the colour primaries of the picture resulting from applying the NNPF specified in the SEI message, rather than the colour primaries used for the CLVS.
When nnpfc_colour_primaries is not present in the NNPFC SEI message, the value of nnpfc_colour_primaries is inferred to be equal to vui_colour_primaries.

nnpfc_transfer_characteristics has the same semantics as specified in JVET-AC2032 subclause 7.3 for the vui_transfer_characteristics syntax element, except as follows:
nnpfc_transfer_characteristics specifies the transfer characteristics of the picture resulting from applying the NNPF specified in the SEI message, rather than the transfer characteristics used for the CLVS.
When nnpfc_transfer_characteristics is not present in the NNPFC SEI message, the value of nnpfc_transfer_characteristics is inferred to be equal to vui_transfer_characteristics.

nnpfc_matrix_coeffs has the same semantics as specified in JVET-AC2032 subclause 7.3 for the vui_matrix_coeffs syntax element, except as follows:
nnpfc_matrix_coeffs specifies the matrix coefficients of the picture resulting from applying the NNPF specified in the SEI message, rather than the matrix coefficients used for the CLVS.
When nnpfc_matrix_coeffs is not present in the NNPFC SEI message, the value of nnpfc_matrix_coeffs is inferred to be equal to vui_matrix_coeffs.
The values allowed for nnpfc_matrix_coeffs are not constrained by the chroma format of the decoded video pictures that is indicated by the value of ChromaFormatIdc for the semantics of the VUI parameters.
When nnpfc_matrix_coeffs is equal to 0, nnpfc_out_order_idc shall not be equal to 1 or 3.

### Frame-Field Information SEI Message

The frame-field information SEI message provides information on how the picture associated with the SEI message should be displayed. This includes whether the picture is of progressive or interlaced video format. In a progressive video format, each picture is a full picture or a frame, whereas in an interlaced video format, each picture comprises of two fields that are interleaved line-by-line, with each field captured at a different point in time. On certain displays that uses interlaced scanning the perception of higher frame rate can be achieved with interlaced video. The usage of interlaced video is less common nowadays, but still there is quite some content around that was captured in interlaced format. The process of converting from interlaced format to progressive format is referred to as deinterlacing.

The syntax for the frame-field information SEI message is shown in Table 5 below with semantics relevant for this disclosure.

TABLE 5

| frame_field_info( payloadSize ) { | Descriptor |
|---|---|
| ffi_field_pic_flag | u(1) |
| if( ffi_field_pic_flag ) { | |
| ffi_bottom_field_flag | u(1) |
| ffi_pairing_indicated_flag | u(1) |
| if( ffi_pairing_indicated_flag ) | |
| ffi_paired_with_next_field_flag | u(1) |
| } else { | |
| ffi_display_fields_from_frame_flag | u(1) |
| if( ffi_display_fields_from_frame_flag ) | |
| ffi_top_field_first_flag | u(1) |
| ffi_display_elemental_periods_minus1 | u(8) |
| } | |
| ffi_source_scan_type | u(2) |
| ffi_duplicate_flag | u(1) |
| } | |

ffi_field_pic_flag equal to 1 indicates that the display model considers the current picture as a field, and ffi_field_pic_flag equal to 0 indicates that the display model considers the current picture as a frame.

ffi_bottom_field_flag equal to 1, when present, indicates that the current picture is a bottom field (i.e., that the parity of the current picture is bottom). ffi_bottom_field_flag equal to 0 indicates that the current picture is a top field (i.e., that the parity of the current picture is top). The two parities, bottom and top, are considered as opposite parities.

ffi_source_scan_type equal to 1 indicates that the source scan type of the associated picture should be interpreted as progressive. ffi_source_scan_type equal to 0 indicates that the source scan type of the associated picture should be interpreted as interlaced. ffi_source_scan_type equal to 2 indicates that the source scan type of the associated picture is unknown or unspecified or specified by other means not specified in this Specification.

Alpha Channel info SEI Message

Alpha channels of a picture are used to describe the transparency or alternatively the opaqueness of a picture. When the alpha channel only is represented with two bits per pixel, each pixel is either fully transparent or fully opaque. When the alpha channel is associated with a picture it is often represented with the same bit depth as each component of the picture.

The alpha channel information SEI message in VSEI provides information about alpha channel sample values and post-processing applied to the decoded alpha planes coded in auxiliary pictures of type AUX_ALPHA. The syntax of the alpha channel information SEI message is shown below in Table 6:

TABLE 6

| alpha_channel_info( payloadSize ) { | Descriptor |
|---|---|
| alpha_channel_cancel_flag | u(1) |
| if( !alpha_channel_cancel_flag ) { | |
| alpha_channel_use_idc | u(3) |
| alpha_channel_bit_depth_minus8 | u(3) |
| alpha_transparent_value | u(v) |
| alpha_opaque_value | u(v) |
| alpha_channel_incr_flag | u(1) |
| alpha_channel_clip_flag | u(1) |
| if( alpha_channel_clip_flag ) | |
| alpha_channel_clip_type_flag | u(1) |
| } | |
| } | |

### Depth Images and the Depth Representation SEI Message

A depth image is an image that contains information relating to the distance of the surfaces of scene objects from a (camera) viewpoint, where each sample value of the image corresponds to the depth of that sample. Normally just one component is used to represent the depth. Depth images are also sometimes referred to as depth maps, depth pictures, z-buffers or z-depths. Typically, a higher value (lighter luminance) in the depth image corresponds to a point that is close to the camera and a lower value (dark luminance) corresponds to a point that is further away from the camera. This may be reversed in some applications.

Depth images may be used for many different applications including 3D object reconstruction. Depth images may be computer generated or captured, e.g. by a depth image camera, either as a stand-alone camera or a camera producing texture+depth output, e.g. RGBD.

Disparity images are similar to depth images and describes the disparity between objects at different depths. In this disclosure the terms depth image and disparity image are used interchangeably, unless explicitly stated otherwise.

The depth representation information SEI message specifies various parameters for auxiliary pictures of type AUX_DEPTH for the purpose of processing decoded primary and auxiliary pictures prior to rendering on a 3D display, such as view synthesis. Specifically, depth or disparity ranges for depth pictures are specified. The syntax for the depth representation information SEI message is shown in Table 7 below:

TABLE 7

| depth_representation_info( payloadSize ) { | Descriptor |
|---|---|
| z_near_flag | u(1) |
| z_far_flag | u(1) |
| d_min_flag | u(1) |
| d_max_flag | u(1) |
| depth_representation_type | ue(v) |
| if( d_min_flag \| \| d_max_flag ) | |
| disparity_ref_view_id | ue(v) |
| if( z_near_flag ) | |
| depth_rep_info_element( ZNearSign, ZNearExp, ZNearMantissa, | |
| ZNearManLen ) | |
| if( z_far_flag ) | |
| depth_rep_info_element( ZFarSign, ZFarExp, ZFarMantissa, | |
| ZFarManLen ) | |
| if( d_min_flag ) | |
| depth_rep_info_element( DMinSign, DMinExp, DMinMantissa, | |
| DMinManLen ) | |
| if( d_max_flag ) | |
| depth_rep_info_element( DMaxSign, DMaxExp, DMaxMantissa, | |
| DMaxManLen ) | |
| if( depth_representation_type = = 3 ) { | |
| depth_nonlinear_representation_num_minus1 | ue(v) |
| for( i = 1; i <= depth_nonlinear_representation_num minus1 + 1; i++ ) | |
| depth_nonlinear_representation_model[ i ] | ue(v) |
| } | |
| } | |
| depth_rep_info_element( OutSign, OutExp, OutMantissa, OutManLen ) { | Descriptor |
| da_sign_flag | u(1) |
| da_exponent | u(7) |
| da_mantissa_len_minus1 | u(5) |
| da_mantissa | u(v) |
| } | |

Film grain synthesis and the film grain characteristics SEI message in VSEI

VSEI includes a film grain characteristics SEI message that may be used to support a film grain process. The process includes a parametrized model carried in the SEI message for film grain synthesis in the decoder. In the Table 8 below, a simplified version of the syntax is shown.

TABLE 8

| film_grain_characteristics( payloadSize ) { | Descriptor |
|---|---|
| ... | |
| fg_separate_colour_description_present_flag | u(1) |
| if( fg_separate_colour_description_present_flag ) { | |
| fg_bit_depth_luma_minus8 | u(3) |
| fg_bit_depth_chroma_minus8 | u(3) |
| fg_full_range_flag | u(1) |
| fg_colour_primaries | u(8) |
| fg_transfer_characteristics | u(8) |
| fg_matrix_coeffs | u(8) |
| } | |
| fg_blending_mode_id | u(2) |
| fg_log2_scale_factor | u(4) |
| for(c = 0; c < 3; c++ ) | |
| fg_comp_model_present_flag[ c ] | u(1) |
| for( c = 0; c < 3; c++ ) | |
| if( fg_comp_model_present_flag[ c ] ) { | |
| fg_num_intensity_intervals_minus1[ c ] | u(8) |
| fg_num_model_values_minus1 [ c ] | u(3) |
| for( i = 0; i <= fg_num_intensity_intervals_minus1[ c ]; i++ ) { | |
| fg_intensity_interval_lower_bound[ c ][ i ] | u(8) |
| fg_intensity_interval_upper_bound[ c ][ i ] | u(8) |
| for( j = 0; j <= fg_num_model_values_minus1[ c ]; j++) | |
| fg_comp_model_value[ c ][ i ][ j ] | se(v) |
| } | |
| } | |
| ... | |
| } | |
| } | |

### SUMMARY

Certain challenges presently exist. For instance, JVET-AC2032-v2 defines a limited set of purposes for NN post-filtering, and while this limited set covers some significant use cases, a number of important purposes for NN post-filtering that would be beneficial to describe in a video bitstream for which NN post-filters are to be applied for the decoded pictures are missing. That is, the current specification is missing out on useful NN post-filtering purposes and their associated parameters. This limitation can restrict the application of the codec in use cases that could benefit from a more powerful set of NN post-filters. Furthermore, the signalling of the required parameters for each purpose is also limited.

Accordingly, in one aspect there is provided a method for post-processing a decoded picture. The method includes receiving a bitstream and using information encoded in the bitstream (e.g., encoded sample values) to produce the decoded picture. The method also includes obtaining a first set of parameters, the first set of parameters comprising neural network, NN, parameters specifying a NN post-filter, NNPF, having one or more purposes. The method also includes decoding a first indicator value from a first syntax element in the bitstream, the first indicator value indicating the purposes of the NNPF. The one or more purposes include: colour range conversion (including SDR to HDR conversion), deinterlacing, alpha map generation, depth image generation, generation of new views (view synthesis), inpainting (subtitle removal, object removal, etc.), focus and blur, retexturing, restyling (or style transfer), and/or film grain synthesis.

In another aspect there is provided an encoding method. The method includes encoding a first intended input picture to produce a first coded picture. The method also includes including the first coded picture in a bitstream. The method also includes including a message in the bitstream, wherein the message relates to a neural network, NN, post-filter, NNPF, for use in post-filtering a set of one or more intended input pictures, where the set of intended input pictures comprises the first intended input picture, and the message comprises information indicating one or more purposes of the NNPF, wherein the one or more purposes comprise: colour range conversion (including SDR to HDR conversion), deinterlacing, alpha map generation, depth image generation, generation of new views (view synthesis), inpainting (subtitle removal, object removal, etc), focus and blur, retexturing, restyling (or style transfer), and/or film grain synthesis.

In another aspect there is provided a computer program comprising instructions which when executed by processing circuitry of an apparatus causes the apparatus to perform any of the methods disclosed herein. In one embodiment, there is provided a carrier containing the computer program wherein the carrier is one of an electronic signal, an optical signal, a radio signal, and a computer readable storage medium. In another aspect there is provided an apparatus that is configured to perform the methods disclosed herein. The apparatus may include memory and processing circuitry coupled to the memory.

An advantage of embodiments disclosed herein is that they provide a number of purposes and use cases for NNPF processing of pictures not present in JVET-AC2032-v2, where the indication of the purpose is signalled in a bitstream for post-filtering of the decoded pictures of the bitstream. Providing a wider range of NN post-filters is desirable considering the growing use cases of NN post-filters. In addition to the purposes, the embodiments provide additional parameters that further may describe the properties of the NNPF, the properties of the input pictures or the properties of the output pictures resulting from applying the NNPF. These parameters may be essential for a decoder to understand what to input to the NNPF and what output to expect.

### BRIEF DESCRIPTION OF THE DRAWINGS

The accompanying drawings, which are incorporated herein and form part of the specification, illustrate various embodiments.

FIG. 1 illustrates a system according to an embodiment.

FIG. 2 is a schematic block diagram of an encoder according to an embodiment.

FIG. 3 is a schematic block diagram of a decoder according to an embodiment.

FIG. 4 is a flowchart illustrating a process according to an embodiment.

FIG. 5 is a flowchart illustrating an encoding process according to an embodiment.

FIG. 6 is a block diagram of an apparatus according to an embodiment.

### DETAILED DESCRIPTION

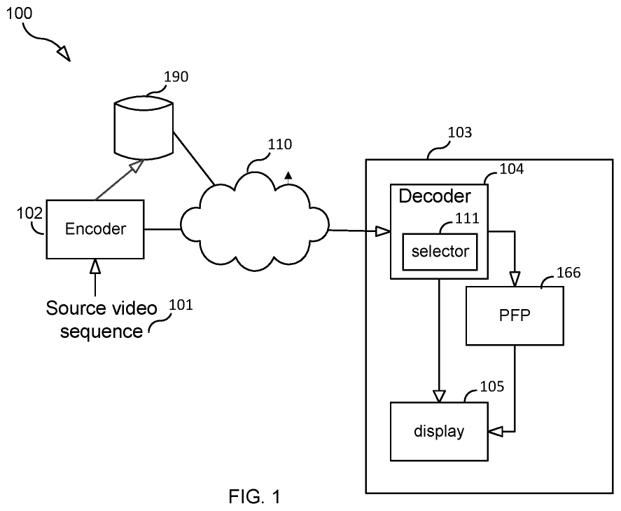

FIG. 1 illustrates a system 100 according to an embodiment. System 100 includes an encoder 102 and a decoder 104, wherein encoder 102 is in communication with decoder 104 via a network 110 (e.g., the Internet or other network). In one embodiment, encoder 102 encodes a video sequence 101 into a bitstream comprising an encoded video sequence and transmits the bitstream to decoder 104 via network 110. In some embodiments, rather than transmitting bitstream to decoder 104, the bitstream is stored in a data storage unit 190 and decoder 104 retrieves from the data storage unit the bitstream containing the encoded video sequence. Data storage unit 190 may be co-located with encoder 102 or may be remote from encoder 102. Decoder 104 decodes the encoded video sequence to produce video data for display and/or post processing. Accordingly, decoder 104 may be part of a receiving device 103 either having a display device 105 or connected to a display device. The device 103 may be a mobile device, a TV set, a set-top device, a head-mounted display, a transcoding device, or any other device. Additionally, as shown in FIG. 1, device 103 may include a NNPF processor (PFP) 166 that may receive a decoded picture from decoder 104 and that may process the picture using a specified NNPF. In the embodiment shown, PFP 166 is separate from decoder 104, but in other embodiments, PFP 166 may be a component of decoder 104.

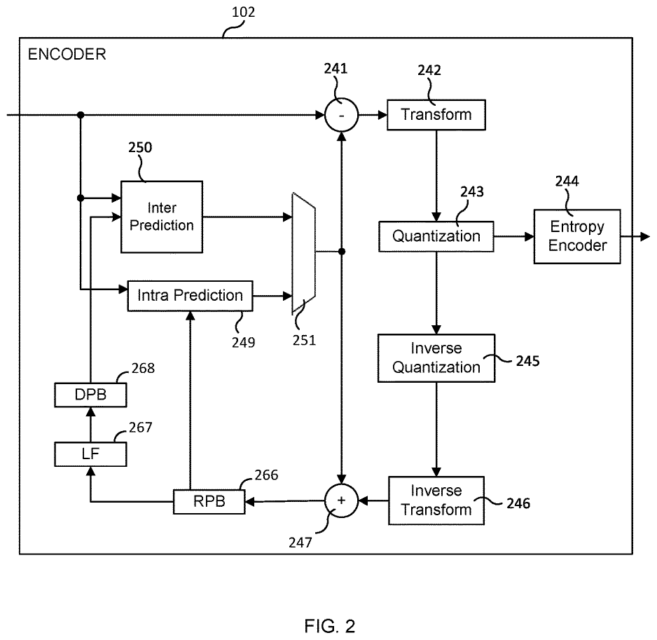

FIG. 2 illustrates functional components of encoder 102 according to some embodiments. It should be noted that encoders may be implemented differently so implementation other than this specific example can be used. Encoder 102 employs a subtractor 241 to produce a residual block which is the difference in pixel values between an input block and a prediction block (i.e., the output of a selector 251, which is either an inter prediction block output by an inter predictor 250 (a.k.a., motion compensator) or an intra prediction block output by an intra predictor 249). Then a forward transform 242 and forward quantization 243 is performed on the residual block as well known in the current art. This produces transform coefficients which are then encoded into the bitstream by encoder 244 (e.g., an entropy encoder) and the bitstream with the encoded transform coefficients is output from encoder 102. Next, encoder 102 uses the transform coefficients to produce a reconstructed block. This is done by first applying inverse quantization 245 and inverse transform 246 to the transform coefficients to produce a reconstructed residual block and using an adder 247 to add the prediction block to the reconstructed residual block, thereby producing the reconstructed block, which is stored in the reconstruction picture buffer (RPB) 266. Loop filtering by a loop filter (LF) stage 267 is applied and the final decoded picture is stored in a decoded picture buffer (DPB) 268, where it can then be used by the inter predictor 250 to produce an inter prediction block for the next picture to be processed. LF stage 267 may include four sub-stages: i) a deblocking filter, ii) an SAO filter, iii) an ALF and iv) an LMCS filter.

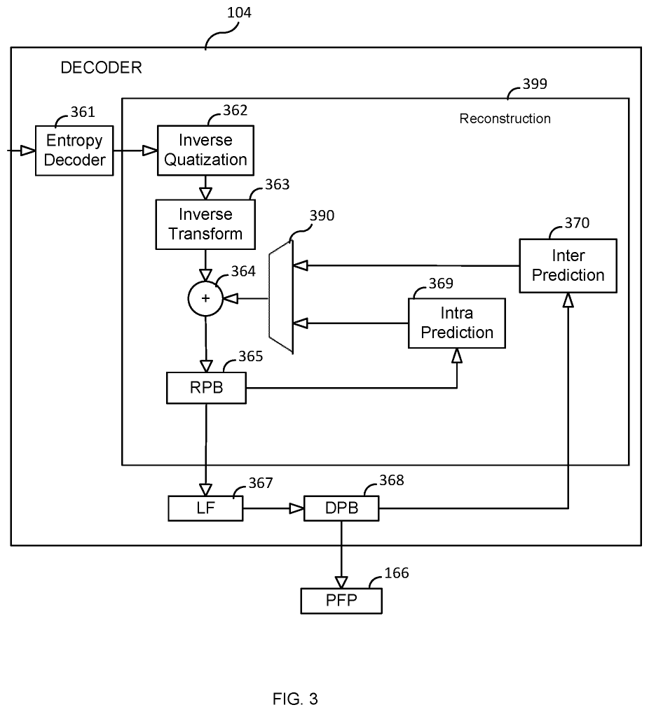

FIG. 3 illustrates functional components of decoder 104 according to some embodiments. It should be noted that decoder 104 may be implemented differently so implementations other than this specific example can be used. Decoder 104 includes a decoder module 361 (e.g., an entropy decoder) that decodes from the bitstream transform coefficient values of a block. Decoder 104 also includes a reconstruction stage 399 in which the transform coefficient values are subject to an inverse quantization process 362 and inverse transform process 363 to produce a residual block. This residual block is input to adder 364 that adds the residual block and a prediction block output from selector 390 to form a reconstructed block. Selector 390 either selects to output an inter prediction block or an intra prediction block. The reconstructed block is stored in a reconstructed picture buffer (RPB) 365. The inter prediction block is generated by the inter prediction module 370 and the intra prediction block is generated by the intra prediction module 369. Following the reconstruction stage 399, a loop filter stage 367 applies loop filtering and the final decoded picture may be stored in a decoded picture buffer (DPB) 368 and output to PFP 166. Pictures are stored in the DPB for two primary reasons: 1) to wait for picture output and 2) to be used for reference when decoding future pictures.

### Parameters for the NNPF

This disclosure describes a method in which receiver 103 receives a bitstream (e.g., from encoder 102 or data storage unit 190), where the bitstream comprises one or more pictures and parameters for an NNPF or a reference to an NNPF associated with the one or more pictures, and an indicator value where the indicator value indicates the purpose of the NNPF. Based on the indication of the purpose, the receiver may determine whether to have PFP 166 apply the NNPF to the one or more pictures or not.

The bitstream may be a video bitstream or a bitstream comprising a single image/picture. The purpose may be one or more of the following:
a. Colour range conversion (including SDR to HDR conversion);
b. Deinterlacing;
c. Alpha map generation;
d. Depth image generation;
e. Generation of new views (view synthesis);
f. Inpainting (subtitle removal, object removal, etc.);
g. Focus and blur;
h. Retexturing, restyling (or style transfer);
i. Film grain synthesis.

Referring back to FIG. 1, receiver 103 receives a bitstream from a sender. The sender may be encoder 102, which first encodes the bitstream, or data storage unit 190, where the bitstream is stored before sending it. Receiver 103 includes a decoder 104 that decodes one or more pictures from the bitstream. The decoder also decodes an indicator value from the bitstream, wherein the indicator value indicates a purpose of a specified NNPF associated with the one or more decoded pictures. A selector 111 determines based on the indicator value whether to have PFP 166 post-filter the decoded picture using the NNPF, or not. The selector 111 may for instance reside in the decoder 104.

The decoder decodes a first set of parameters from the bitstream, wherein the first set of parameters comprises NN parameters for the NNPF. Alternatively, the decoder decodes a reference (e.g., Uniform Resource Identifier (URI)) to a location where the first set of parameters are located and the first set of parameters are retrieved from there. The first set of parameters may include the tensors (weights) of a NN and including the respective NN structure or connection graph and other parameters for specifying a generic NN. The first set of parameters may have been compressed, e.g., by using the Compression of neural networks for multimedia content description and analysis standard, ISO/IEC 15938-17, also referred to as Neural Network compression and Representation (NNR).

If the selector determines that the one or more decoded pictures is to be post-filtered by PFP 166 using the NNPF, the one or more decoded pictures are input to PFP 166, together with the obtained NN parameters for the NNPF (a second set of parameters may also be input to PFP 166 depending on the purpose of the NNPF). PFP 166 uses the NN parameters, the second set of parameters, if any, and the one or more decoded pictures to produce one or more post-filtered pictures. That is, PFP 166 filters the one or more decoded pictures based on the input parameters and outputs one or more post-filtered pictures. PFP 166 may be a part of the decoder, or it may be detached from the decoder.

The decoder may decode the second set of parameters, where the second set of parameters comprises information about the input to the NNPF (e.g., format of the decoded picture(s)) or output from to the NNPF (e.g., the post-filtered picture(s)) or other metadata for the NNPF. The decision whether to decode the second set of parameters may be based on the indicator value. The second set of parameters may comprise one or more parameters.

In some embodiments, a second indicator is decoded from the bitstream, wherein the decision whether to apply the NNPF is based on the second indicator. For instance, in a normative solution where it would be mandatory for a receiver to follow the instruction of whether to use the NNPF or not to be compliant to a standard, the indicator value indicates the purpose of the NNPF and the second indicator value specifies whether to apply the NNPF to the decoded pictures or not. In another example, in response to the second indicator having a first value, the decoder should not apply the NNPF to the decoded picture, and in response to the second indicator having a second value, the decoder may apply the NNPF to the decoded picture. The second indicator may for instance be signalled in a parameter set, header or SEI message. In one version the decision whether to decode the second set of parameters are based on the second indicator value.

In some embodiments, the purpose of the NNPF is defined for only a part of the picture, e.g., for a slice, tile, subpicture or by some other portion of the picture.

The indicator value may be signaled in an SEI message, a VUI structure, a parameter set (such as a DPS, VPS, SPS, PPS or APS), and/or a header (such as a picture header or slice header). The indicator value may alternatively be obtained by other means, e.g., as part of a DASH manifest, a local storage, pre-downloaded, or the like.

One or more of the second set of parameters may be signaled in an SEI message, a VUI structure, a parameter set, and/or a header. One or more of the second set of parameters may also be obtained by referencing parameters from such structures, e.g., a parameter in the VUI or an SEI message, or parameters in a parameter set, such as the subpicture structure of the SPS, e.g., by referring to the parameter structure with an identifier, such as an SPS ID. One or more of the second set of parameters may alternatively be obtained by other means, e.g., as part of a DASH manifest, a local storage, pre-downloaded, or the like.

In some embodiments, PFP 166, as a result of post-processing the decoded picture using the input parameters, outputs: one or more post-processed pictures, one or more texts, and/or one or more sounds or audio clips.

In some embodiments, receiver 103 may perform all or a subset of the following steps:

Step 1: Receiving a bitstream.

Step 2: Decoding one or more coded pictures from the bitstream to produce one or more decoded pictures. That is, using information encoded in the bitstream (e.g., encoded sample values) to produce the decoded picture(s).

Step 3: Obtaining a first set of parameters specifying an NNPF (i.e., the first set of parameters comprises a set of NN parameters). Obtaining the first set parameters may comprise decoding at least some of the NN parameters from the bitstream and/or downloading at least some of the NN parameters from a server (e.g., an HTTP server). For example, obtaining the first set of parameters may comprise decoding a reference, e.g., URI, such as a URL, describing where the first set of parameters is located and then obtaining the parameters from that location. The NN parameters may also be obtained by external means, e.g., from local storage, pre-downloaded, etc.

Step 4: Decoding an indicator value from the bitstream, the indicator value indicating the purpose of the NNPF, wherein the purpose comprises:
a. Colour range conversion (including SDR to HDR conversion);
b. Deinterlacing;
c. Alpha map generation;
d. Depth image generation;
e. Generation of new views (view synthesis);
f. Inpainting (subtitle removal, object removal, etc);
g. Focus and blur;
h. Retexturing, restyling (or style transfer); and/or
i. Film grain synthesis.

The indicator may be signaled in at least one of a SEI message, parameter set, such as a DPS, VPS, SPS, PPS or APS, or header, such as a picture header or slice header.

Step 5: Obtaining (e.g., decoding from the bitstream) a second set of parameters, where the second set of parameters comprises information about the input to the NNPF (e.g. format of the decoded picture(s)) or output from to the NNPF (e.g. the post-filtered picture(s)) or other metadata for the NNPF. A decision whether to obtain the second set of parameters may be based on the indicator value. Alternatively, the presence of the second set of parameters in the bitstream may depend on the indicator value. The second set of parameters may comprise one or more parameters. A parameter may correspond to a syntax element.

Step 6: Based on the indicator value, determining whether to have PFP 166 post-filter the decoded picture using the obtained first and second set of parameters, if any.

Step 7: In response to determining to post-filter the decoded picture using the obtained parameters, post-filtering the decoded picture using the obtained NN parameters and (if present and applicable) the second set of parameters.

The second set of parameters may comprise one or more of the parameters identified in the Table 9 below:

TABLE 9

- Camera parameters, such as intrinsic parameters including focal length, principal point
and skew factor and/or extrinsic parameters including rotation and translation.
- Temporal identifier of an input or output picture, such as a time stamp, POC or delta
POC.
- Saturation level as the color difference in the RGB channels. Higher color difference in
the RGB channels is corresponding to a higher saturation level, for instance an RGB value
of (125, 125, 125) has zero saturation and an RGB value of (255, 0, 0) is fully saturated.
Changing the saturation level is then done by defining a mapping between the current
color-difference in the RGB channels and the desired color difference in the RGB
channels. The mapping may be described or signalled in various ways e.g. a polynomial
function, a linear approximation or by a lookup table.
- Contrast level as the distinction between lighter and darker areas of the picture. A
mapping between the current level of contrast in the picture and the desired contrast may
be described or signalled in the form of a polynomial function, a linear approximation, or a
lookup table.
- A colour palette or a colour lookup table (CLUT) which defines a mapping between an
index and a color. Using this mapping, each pixel in the picture is assigned a colour,
defined by the index value in that pixel. A new colour palette is then a new mapping
between the index and the colour. This new mapping can be signalled or stored in a defined
file format. Colors are usually stored in RGB format within the palettes of indexed image
files.
- Texture or style templates which are graphic resources stored in a defined format in the
form of a file. Some known source texture formats are EXR, PSD and TIF which are
editable. Runtime texture formats can be directly used for rendering, for instance by a
game engine and may be compressed lossy or lossless. Since textures and styles can give
the impression of a material, they are common to be referenced by the name of the
material, such as “marbl” or “wood”. Texture or style templates can be stored in image
formats. The texture or style can be obtained by decoding a reference, e.g. URI or URL,
describing where the texture or style is located and then obtaining this graphical resource
from that location.
- Attributes in the form of labels which are high level descriptors of more complex data
formats such as textures, styles, color pallets, etc.
- Seed value to produce random or pseudo-random numbers. The seed value is used by a
method or algorithm to produce the random or pseudo-random numbers. Seed value may
have a defined number of bits and may be used to initialize the pseudo-random generator.
- Chroma phase parameters, i.e., for the chroma sample position relative to the luma
sample in a chroma subsampled picture. These parameters may include chroma format
type, chroma format location type, and horizontal and/or vertical chroma phase offsets.
- Aspect ratio parameters, including with and height of the sample aspect ratio,
representing the intended display or output aspect ratio of a picture.
- A text string describing the purpose of the NNPF. This text string may contain any text
the sender wants to use to describe the purpose of the NNPF. In one embodiment, this text
string is only signaled when the purpose of the NNPF is set to unspecified.
- Layer id and/or layer information for input pictures to the NNPF and layer id and/or layer
information for pictures output from the NNPF. The layer information may comprise
information on the type of data for each layer, e.g. , if it is texture or depth and to what view
it belongs. For instance, in a multi-layer bitstream, e.g. where one layer carries depth and
another layer carries texture info, it is signaled in the second set of parameters which of the
layers are the ones that carry depth and texture data. The NN postfilter then uses this
knowledge to perform a depth dependent process on the texture data.

Syntax and semantics for how input and output layer information may be signaled is shown in Table 10 and Table 11 below, where the purpose_indicator equal to X, where X is a particular pre-defined value, specifies that the layer information is signaled:

TABLE 10
SYNTAX

| | Descriptor |
|---|---|
| purpose_indicator | u(16) |
| ... | |
| if (purpose_indicator == X ) { | |
| num_input_layers_minus1 | ue(v) |
| for ( i = 0; i <= num_input_layers_minus1; i++) | |
| input_layer_id [ i ] | ue(v) |
| input_view_id [ i ] | ue(v) |
| input_depth_layer_flag [ i ] | u(1) |
| if ( input_depth_layer_flag [ i ] ) | |
| input_associated_layer_id [ i ] | ue(v) |
| } | |
| num_output_layers_minus1 | ue(v) |
| for ( i = 0; i <= num_output_layers_minus1; i++ ) | |
| output_layer_id [ i ] | ue(v) |
| output_view_id [ i ] | ue(v) |
| output_depth_layer_flag [ i ] | u(1) |
| if ( output_depth_layer_flag [ i ] ) | |
| output_associated_layer_id [ i ] | ue(v) |
| } | |
| } | |
| ... | |
| } | |

TABLE 11
SEMANTICS

num_input_layers_minus1 plus 1 specifies the number of input layers for the NNPF.
input_layer_id [ i ] specifies the layer id of the i-th input layer used by the NNPF.
input_view_id [ i ] specifies the view id of the i-th input layer used by the NNPF.
input_depth_layer_flag [ i ] specifies whether the i-th layer is a depth layer.
input_associated_layer_id [ i ] specifies the layer id of the (texture) layer associated with
the depth layer.
num_output_layers_minus1 plus 1 specifies the number of output layers for the NNPF.
output_layer_id [ i ] specifies the layer id of the i-th output layer used by the NNPF.
output_view_id [ i ] specifies the view id of the i-th output layer used by the NNPF.
output_depth_layer_flag [ i ] specifies whether the i-th layer is a depth layer.
output_associated_layer_id [ i ] specifies the layer id of the (texture) layer associated
with the depth layer i.

In one embodiment, the same or similar syntax and/or semantics are used for at least one of the parameters in the second set of parameters, as in the Scalable dimension information SEI message in VSEI.

In addition, some of embodiments below describe further realizations of the one or more parameters in the second set of parameters. It is to be understood that those realizations are not restricted to those specific purposes of those embodiments but may be used also for other purposes.

### Further Details on Various Purposes

Converting Colour Range (Including from SDR to HDR)

In one embodiment, the purpose of the NN post-filter is to convert a picture from one color range to another. One example of this is when converting a picture from SDR to HDR.

In one embodiment, based on the indicator value indicating a purpose to convert from one color range to another, a second set of parameters are present and are decoded from the bitstream. The second set of parameters may include information about the colour primaries, transfer characteristics, and/or matrix coefficients of the picture or pictures that is output from the NNPF.

This embodiment is illustrated with the syntax shown in Table 12 below, where the purpose_indicator equal to X (where X is a particular pre-defined value) indicates that the purpose of the NNPF is to convert the picture from one color range to another.

TABLE 12

| | Descriptor |
|---|---|
| purpose_indicator | u(16) |
| ... | |
| if (purpose_indicator == X ) { | |
| colour_primaries | u(8) |
| transfer_characteristics | u(8) |
| matrix_coeffs | u(8) |
| } | |
| ... | |
| } | |

A version of the embodiment, where a bitmask is used to extract the purpose of a nnpfc_purpose syntax element is illustrated in Table 13 below on top of the syntax and semantics of JVET-AC2032-v2 with added text in italics and removed text between brackets

TABLE 13

| nn_post_filter_characteristics( payloadSize ) { | Descriptor |
|---|---|
| nnpfc_purpose | u(16) |
| ... | |
| if (nnpfc_purpose & 0x30 != 0 ) { | |
| [nnpfc_separate_colour_description_present_flag]] | [[u(1)] |
| [[if( nnpfc_separate_colour_description_present_flag ) {]] | |
| nnpfc_colour_primaries | u(8) |
| nnpfc_transfer_characteristics | u(8) |
| nnpfc_matrix_coeffs | u(8) |
| } | |
| ... | |
| } | |

nnpfc_purpose indicates the purpose of the NNPF as shown in the Table 14 below.

TABLE 14

| Value | Interpretation |
|---|---|
| nnpfc_purpose = = 0 | May be used as determined by the application |
| nnpfc_purpose > 0 && | No general visual quality improvement |
| ( nnpfc_purpose & | |
| 0x01 ) = = 0 | |
| ( nnpfc_purpose & | With general visual quality improvement |
| 0x01 ) != 0 | |
| nnpfc_purpose > 0 && | No chroma upsampling (from the 4:2:0 chroma format to the 4:2:2 |
| ( nnpfc_purpose & | or 4:4:4 chroma format, or from the 4:2:2 chroma format to the |
| 0x02 ) = = 0 | 4:4:4 chroma format) |
| ( nnpfc_purpose & | With chroma upsampling |
| 0x02 ) != 0 | |
| nnpfc_purpose > 0 && | No resolution upsampling (increasing the width or height) |
| ( nnpfc_purpose & | |
| 0x04 ) = = 0 | |
| ( nnpfc_purpose & | With resolution upsampling |
| 0x04 ) != 0 | |
| nnpfc_purpose > 0 && | No picture rate upsampling |
| ( nnpfc_purpose & | |
| 0x08 ) = = 0 | |
| ( nnpfc_purpose & | With picture rate upsampling |
| 0x08 ) != 0 | |
| nnpfc_purpose > 0 && | No bit depth upsampling (increasing the luma bit depth or the |
| ( nnpfc_purpose & | chroma bit depth) |
| 0x10 ) = = 0 | |
| ( nnpfc_purpose & | With bit depth upsampling |
| 0x10 ) != 0 | |
| nnpfc_purpose > 0 && | No colourization (from the 4:0:0 chroma format to the 4:2:0, 4:2:2, |
| ( nnpfc_purpose & | or 4:4:4 chroma format) |
| 0x20 ) = = 0 | |
| ( nnpfc_purpose & | With colourization |
| 0x20 ) != 0 | |
| nnpfc_{—}purpose > 0 && | No colour range conversion (e.g., from SDR to HDR) |
| ( nnpfc_{—}purpose & | |
| 0x30 ) = = 0 | |
| ( nnpfc_{—}purpose & | With colour range conversion |
| 0x30 ) != 0 | |

The semantics of nnpfc_purpose can be expressed more compact as:

nnpfc_purpose indicates the purpose of the NNPF, where (nnpfc_purpose & bitmask) not equal to 0 indicates that the purpose associated with the bitmask value in the NNPFC Purpose Table is indicated. nnpfc_purpose>0 and (nnpfc_purpose & bitmask) equal to 0 indicates that a purpose is not indicated. When nnpfc_purpose is equal to 0, the NNPF may be used as determined by the application.

In one embodiment, the value of nnpfc_purpose shall be in the range of 0 to 63, inclusive, and values of 64 to 65535, inclusive, for nnpfc_purpose are reserved for future use and shall not be present. Conforming decoders shall ignore NNPFC SEI messages with nnpfc_purpose in the range of 64 to 65535, inclusive.

TABLE 15
NNPFC Purpose Table

| Bitmask | Interpretation |
|---|---|
| 0x01 | General visual quality improvement |
| 0x02 | Chroma upsampling (from the 4:2:0 chroma format to the 4:2:2 or 4:4:4 chroma |
| | format, or from the 4:2:2 chroma format to the 4:4:4 chroma format) |
| 0x04 | Resolution upsampling (increasing the width or height) |
| 0x08 | Picture rate upsampling |
| 0x10 | Bit depth upsampling (increasing the luma bit depth or the chroma bit depth) |
| 0x20 | Colourization (from the 4:0:0 chroma format to the 4:2:0, 4:2:2, or 4:4:4 |
| | chroma format) |
| 0x30 | Colour range conversion (e.g., from SDR to HDR) |

In one embodiment, the syntax of JVET-AC2032-v2 is not changed, but the following text is added to the semantics.

TABLE 16

| Value | Interpretation |
|---|---|
| . . . | . . . |
| nnpfc_purpose > 0 && | No colour range conversion |
| ( nnpfc_purpose & | (e.g., from SDR to HDR) |
| 0x30 ) = = 0 | |
| ( nnpfc_purpose & | With colour range conversion |
| 0x30 ) != 0 | |

When nnpfc_purpose & 0x30 is equal to 0 nnpfc_separate_colour_description_present_flag shall be equal to 0 and when nnpfc_purpose & 0x30 is not equal to 0 nnpfc_separate_colour_description_present_flag shall be equal to 1.

A decoder may perform all or a subset of the following steps for this embodiment:

Step 1: Decode a coded picture from the bitstream (which may be referred to as the “current” picture) to produce a decoded picture (referred to below as the “current decoded picture”).

Step 2: Obtaining a first set of parameters specifying an NNPF (i.e., the first set of parameters comprises a set of NN parameters). Obtaining the first set parameters may comprise decoding at least some of the NN parameters from the bitstream and/or downloading at least some of the NN parameters from a server (e.g., an HTTP server). For example, obtaining the first set of parameters may comprise decoding a reference, e.g. URI, describing where the first set of parameters is located and then obtaining the parameters from that location. The NN parameters may also be obtained by external means, e.g., from local storage, pre-downloaded, etc.

Step 3: Decoding a first indicator value from a first syntax element in the bitstream and deriving from the first indicator value that the post-filter is a colour range conversion post-filter, alternatively a SDR to HDR post-filter.

Step 4: Decoding one or more values from one or more syntax elements in the bitstream and deriving at least one of colour primaries, transfer characteristics, and matrix coefficients of the at least one NN output picture from the one or more values.

Step 5: Apply the NN postfilter using the current decoded picture (and possible other decoded pictures) as input to the NN postfilter, to output at least one NN output picture from the NN postfilter

One or more of the following two listed items may be combined with these steps: (1) The first and the one or more syntax elements are present in at least one of a SEI message, parameter set, or header; (2) The presence of the one or more syntax elements depends on deriving that the post-filter is a color range conversion (alt. SDR to HDR) post-filter, such that the one or more syntax elements are only present in the bitstream and decoded from the bitstream if the post-filter is derived to be a color range conversion (alt. SDR to HDR) post-filter.

### Deinterlacing

In one embodiment, the purpose of the NN post-filter is to deinterlace one or more pictures, i.e., convert a picture from an interlaced format to a progressive format.

In one embodiment, the second set of parameters are decoded from the bitstream and used to describe properties of the filter, properties of the input pictures to the filter, and/or properties of the output pictures from the filter, and may be used as input to the NNPF. The second set of parameters may include one or more of:
(1) Information whether the input picture(s) to the NN post-filter comprises one or two fields;
(2) Information about what field comes first in the input picture(s). (for the case the picture(s) comprises two fields);
(3) Information whether a particular picture is a top field or bottom field. The particular picture may be the picture associated with the second set of parameters (for the case the picture comprises one field);
(4) Information about the picture(s) that are output from the filter such as the number of pictures that are output, indication of the output order of the pictures that are output, and the height and/or width of the output pictures;
(5) Pointers, e.g. POC, to the input pictures used by the NNPF to deinterlace the current decoded picture (and/or other decoded picture) (more than one input picture could be beneficial for a NN when performing deinterlacing on a decoded picture).

In one embodiment, decoding the second set of parameters is based on the indicator value indicating a purpose to deinterlace the picture, for at least one parameter in the second set of parameters.

Alternatively, the presence of at least one parameter in the second set of parameters in the bitstream depends on the indicator value indicating the purpose to deinterlace the picture.

This embodiment is illustrated with the syntax and semantics below, where the purpose_indicator equal to X, where X is a particular pre-defined value, indicates that the purpose of the NNPF is to deinterlace the associated current decoded picture or pictures.

TABLE 17

| | Descriptor |
|---|---|
| purpose_indicator | u(16) |
| ... | |
| if (purpose_indicator == X ) | |
| top_field_first_flag | u(1) |
| ... | |
| } | |

top_field_first_flag equal to 1, when present, indicates that the first field of the picture(s) that are input to the filter is the top field. top_field_first_flag equal to 0, when present, indicates that the first field of the picture(s) that are input to the filter is the bottom field.

TABLE 18

| | Descriptor |
|---|---|
| purpose_indicator | u(16) |
| ... | |
| if (purpose_indicator == X ) | |
| bottom_field_flag | u(1) |
| ... | |
| } | |

bottom_field_flag equal to 1, when present, indicates that the picture that is input to the filter is a bottom field (i.e., that the parity of the picture is bottom). bottom_field_flag equal to 0 indicates that the picture is a top field (i.e., that the parity of the picture is top). In case multiple pictures are input to the filter, either bottom_field_flag is signalled for each input picture, or bottom_field_flag is indicating the property for one picture (e.g. the input picture that is last in output order) and the properties for the remaining pictures are derived (e.g. the second last picture has the opposite parity and every second picture then is assigned to have the same parity)

TABLE 19

| | Descriptor |
|---|---|
| purpose_indicator | u(16) |
| ... | |
| if (purpose_indicator == X ) { | |
| field_flag | u(1) |
| if (field_flag ) | |
| bottom_field_flag | u(1) |
| else | |
| top_field_first_flag | u(1) |
| } | |
| ... | |
| } | |

field_flag equal to 1 indicates that pictures that are input to the filter are field pictures (pictures comprises one field), and field_flag equal to 0 indicates that the pictures that are input to the filter are frame pictures (pictures comprises two fields).

In one embodiment, a bitmask is used to extract the purpose from a purpose syntax element, in the same way as it is described above. This is also understood to be an alternative way to determine the purpose.

In one embodiment, the same or similar syntax and/or semantics are used for at least one parameter in the second set of parameters, as in the Frame-field information SEI message in VSEI.

In one embodiment, if the purpose of the NNPF is to deinterlace one or more pictures, then the scan type of the picture(s) output from the NNPF is derived as a progressive scan type.

In one embodiment, if the purpose of the NNPF is identified to deinterlace one or more pictures, then at least one of the height of the NNPF output picture(s) (or simply “output picture(s)” for short) and the number of output pictures are decoded from the bitstream. The width of the output picture(s) and/or the temporal positions of the output pictures may additionally be decoded from the bitstream. In one embodiment, the width and/or height of the output picture(s) are smaller than the width and/or height of the input picture(s). Reducing the height by a factor of two for the output picture(s) compared to the decoded input picture(s) may be necessary when the decoded picture(s) are fields. To support the conversion from 1080i to 720p it may also be necessary to allow for a smaller width and height of the output picture(s) compared to the input picture(s). Changing the number of output pictures compared to the number of decoded input pictures may be necessary to support interlaced full picture format (e.g., 1080i50 stored interlaced in full size 1080p25 frames) and 3:2 pull down (e.g., conversion from 24 fps to 30 fps).

In one embodiment, the decoding of at least one of the output height, output width, number of output pictures, and the temporal positions of the output pictures from the NNPF is done if either the purpose indicator value indicates that the purpose of the NN is equal to either or both of a first purpose and the deinterlacing purpose.

In one embodiment this is done with a bitwise ‘or’ operation such that: if ((purpose_indicator & (bitmask_first_purpose|bitmask_deinterlace_purpose))!=0), then decode parameter.

One version of this embodiment is illustrated with the following example syntax and semantics with added text relative to JVET-AC2032-v2 in italics and removed text in brackets [[ ]]. In this example, when the purpose is indicated to deinterlace one or more pictures, then the width and height of the output picture(s), the number of output pictures and the positions of the output pictures are present and may be decoded from the bitstream.

TABLE 20

| nn_post_filter_characteristics( payloadSize ) { | Descriptor |
|---|---|
| nnpfc_purpose | u(16) |
| ... | |
| nnpfc_property_present_flag | u(1) |
| if( nnpfc_property_present_flag ) { | |
| ... | |
| if( ( nnpfc_purpose & 0x20 ) != 0 ) | |
| nnpfc_out_colour_format_idc | u(2) |
| if( ( nnpfc_purpose & (0x04 \| 0x40) ) != 0 ) { | |
| nnpfc_pic_width_in_luma_samples | ue(v) |
| nnpfc_pic_height_in_luma_samples | ue(v) |
| } | |
| if( ( nnpfc_purpose & (0x08 \| 0x40) ) != 0 ) { | |
| for( i = 0; i < nnpfc_num_input_pics_minus1; i++ ) | |
| nnpfc_interpolated_pics[ i ] | ue(v) |
| for( i = 0; i <= nnpfc_num_input_pics_minus1; i++ ) | |
| nnpfc_input_pic_output_flag[ i ] | u(1) |
| } | |
| ... | |
| } | |
| ... | |
| } | |

TABLE 21

| Value | Interpretation |
|---|---|
| nnpfc_purpose = = 0 | May be used as determined by the |
| | application |
| nnpfc_purpose > 0 && | No general visual quality improvement |
| ( nnpfc_purpose & | |
| 0x01 ) = = 0 | |
| ( nnpfc_purpose & | With general visual quality improvement |
| 0x01 ) != 0 | |
| . . . | |
| nnpfc_{—}purpose > 0 && | No deinterlacing |
| ( nnpfc_{—}purpose & | |
| 0x40 ) = = 0 | |
| ( nnpfc_{—}purpose & | With deinterlacing |
| 0x40 ) != 0 | |

. . .

nnpfc_pic_width_in_luma_samples and nnpfc_pic_height_in_luma_samples specify the width and height, respectively, of the luma sample array of the picture resulting from applying the NNPF identified by nnpfc_id to a cropped decoded output picture. When nnpfc_pic_width_in_luma_samples and nnpfc_pic_height_in_luma_samples are not present, they are inferred to be equal to CroppedWidth and CroppedHeight, respectively. When nnpfc_purpose & 0x40 is not equal to 0, the value of nnpfc_pic_width_in_luma_samples shall be in the range of CroppedWidth/2 to CroppedWidth*16-1, inclusive, and the value of nnpfc_pic_height_in_luma_samples shall be in the range of CroppedHeight/2 to CroppedHeight*16-1, inclusive, otherwise, the value of nnpfc_pic_width_in_luma_samples shall be in the range of CroppedWidth to CroppedWidth*16-1, inclusive, and the value of nnpfc_pic_height_in_luma_samples shall be in the range of CroppedHeight to CroppedHeight*16-1, inclusive.
nnpfc_input_pic_output_flag[i] equal to 1 indicates that for the i-th input picture the NNPF generates a corresponding output picture. nnpfc_input_pic_output_flag[i] equal to 0 indicates that for the i-th input picture the NNPF does not generate a corresponding output picture.

The variables numInputPics, specifying the number of pictures used as input for the NNPF, and numOutputPics, specifying the total number of pictures resulting from the NNPF, are derived as follows:

TABLE 22

```
numInputPics = nnpfc_num_input_pics_minus1 + 1
if( ( nnpfc_purpose & (0x08 | 0x40) ) != 0 ) {
  for( i = 0, numOutputPics = 0; i < numInputPics; i++ )
    if( nnpfc_input_pic_output_flag[ i ] )
      numOutputPics++
  for( i = 0; i <= numInputPics - 2; i++ )
    numOutputPics += nnpfc_interpolated_pics[ i ]
} else
  numOutputPics = 1
```

In one embodiment, when the purpose is indicated to be deinterlacing, the width of the picture is not necessarily present. That is illustrated with the syntax below with added text in italics and removed text in brackets [[ ]], relative to JVET-AC2032-v2.

TABLE 23

| nn_post_filter_characteristics( payloadSize ) { | Descriptor |
|---|---|
| ... | |
| if( ( nnpfc_purpose & (0x04 ) != 0 ) [ [{]] | |
| nnpfc_pic_width_in_luma_samples | ue(v) |
| if( ( nnpfc_purpose & (0x04 \| 0x40) ) != 0 ) | |
| nnpfc_pic_height_in_luma_samples | ue(v) |
| [[}]] | |
| ... | |
| } | |

In another version of the embodiment, when the purpose is indicated to be deinterlacing it may be sufficient to indicate whether the output picture height is twice that of the input picture height or not, instead of signaling the height. Syntax and semantics for that is illustrated below with added in italics relative to JVET-AC2032-v2.

TABLE 24

| nn_post_filter_characteristics( payloadSize ) { | Descriptor |
|---|---|
| ... | |
| if( ( nnpfc_purpose & 0x04 ) != 0 ) { | |
| nnpfc_pic_width_in_luma_samples | |
| nnpfc_pic_height_in_luma_samples | |
| } else if ( nnpfc_purpose & 0x40 ) != 0) { | |
| nnpfc_pic_height_times_two_flag | u(1) |
| } | |
| ... | |
| } | |

nnpfc_pic_width_in_luma_samples and nnpfc_pic_height_in_luma_samples specify the width and height, respectively, of the luma sample array of the picture resulting from applying the NNPF identified by nnpfc_id to a cropped decoded output picture. When nnpfc_pic_width_in_luma_samples and nnpfc_pic_height_in_luma_samples are not present, they are inferred to be equal to CroppedWidth and CroppedHeight*(nnpfc_pic_height_times_two_flag*2), respectively. The value of nnpfc_pic_width_in_luma_samples shall be in the range of CroppedWidth to CroppedWidth*16-1, inclusive. The value of nnpfc_pic_height_in_luma_samples shall be in the range of CroppedHeight to CroppedHeight*16-1, inclusive.

nnpfc_pic_height_times_two_flag equal to 1 specifies that the height of the luma sample array of the picture resulting from applying the NNPF identified by nnpfc_id is equal to CroppedHeight*2. nnpfc_pic_height_times_two_flag equal to 0 specifies that the height of the luma sample array of the picture resulting from applying the NNPF identified by nnpfc_id may or may not be equal to CroppedHeight*2. When not present, the value of nnpfc_pic_height_times_two_flag is inferred to be equal to 0.

A decoder may perform one or more of the following steps for this embodiment:

Step 1: Decode a coded picture from the bitstream (which may be referred to as the “current” picture) to produce a decoded picture (referred to below as the “current decoded picture”).

Step 2: Obtaining a first set of parameters specifying an NNPF (i.e., the first set of parameters comprises a set of NN parameters). Obtaining the first set parameters may comprise decoding at least some of the NN parameters from the bitstream and/or downloading at least some of the NN parameters from a server (e.g., an HTTP server). For example, obtaining the first set of parameters may comprise decoding a reference, e.g. URI, describing where the first set of parameters is located and then obtaining the parameters from that location. The NN parameters may also be obtained by external means, e.g., from local storage, pre-downloaded, etc.

Step 3: Decoding a first indicator value from a first syntax element in the bitstream and deriving from the first indicator value that the NNPF is a deinterlacing post-filter.

Step 4: Decoding a second value from a second syntax element in the bitstream and deriving a spatial height of the at least one NN output picture from the second value.

Step 5: Decoding one or more additional values from one or more additional syntax elements from where at least one of the following is derived; the number of input pictures to the NN post-filter, information about the picture(s) that are output from the NN post-filter, such as the number of pictures that are output and the output order of the pictures that are output.

Step 6: Apply the NNPF using the decoded picture (and possible other decoded pictures) as input to the NNPF, to output at least one NN output picture from the NNPF.

One or more of the following 5 listed items may be combined with these steps:
1. The first and second syntax element are present in at least one of a SEI message, parameter set, or header.
2. The presence of the second syntax element depends on deriving that the post-filter is a deinterlacing post-filter, such that the second syntax element is only present in the bitstream and decoded from the bitstream if the post-filter is derived to be a deinterlacing post-filter.
3. The decoder may from the derivation that the post-filter is a deinterlacing post-filter derive that the at least one NN output picture are progressive scan pictures. This information that the at least one NN output picture are progressive scan pictures may be conveyed from the decoder or NN postfilter to an external entity by means of e.g., an API value, a value in a data structure or as a value returned by a function.
4. The deriving from the first indicator value that the post-filter is a deinterlacing post-filter may comprise a binary- or operation between the first indicator value and a constant value.
5. The second syntax element is a binary flag where one value of the flag specifies that the spatial height of the at least one NN output picture is equal to the spatial height of the decoded picture, and the other value of the flag specifies that the spatial height of the at least one NN output picture is equal to two times the spatial height of the decoded picture.

### Alpha Map Generation

In one embodiment, the purpose of the NN post-filter is to create an alpha map or alpha channel, i.e., a picture or component describing the transparency or opaqueness of a picture. The alpha map may be a single picture or it may be a component added to the other components of a picture, e.g. the A in RGBA or YUVA. The alpha map is created by the NNPF using at least the decoded picture as input.

In one embodiment, the second set of parameters are decoded from the bitstream and used to describe properties of the filter, properties of the input pictures to the filter, and/or properties of the output pictures from the filter, and may be used as input to the NNPF.

The second set of parameters may include information on one or more of:
(1) The intended blending usage of the alpha map, which could include whether to multiply the alpha values when applying the alpha map or not, or whether it is unspecified;
(2) The bit depth of the alpha map;
(3) The transparency value of the alpha map, i.e., the interpretation value of samples in the alpha map component for which samples in an associated picture are considered transparent for purposes of alpha blending;
(4) The opaqueness value of the alpha channel, i.e., the interpretation value of samples in the alpha map component for which samples in an associated picture are considered opaque for purposes of alpha blending;
(5) Information about the output format of the alpha map, including whether the alpha map is a single picture or a component of an associated picture.

In one embodiment, the same or similar syntax and/or semantics are used for at least one parameter in the second set of parameters, as in the Alpha channel information SEI message in VSEI.

In one embodiment, decoding the second set of parameters are based on the indicator value indicating a purpose to create an alpha map, for at least one parameter in the second set of parameters.

In one embodiment, the presence of at least one parameter in the second set of parameters in the bitstream depends on the indicator value indicating the purpose to create an alpha channel.

### Depth Image Generation

In one embodiment, the purpose of the NN post-filter is to generate a depth image or disparity image, i.e., a picture or component describing the depth or disparity of the pixels in a picture. The depth image may be a single picture or it may be a component added to the other components of a picture, e.g. the D in RGBD or YUVD. The depth image could be created by the NNPF with the one or more decoded pictures as input. When created from multiple input pictures, the depth image could be generated from multiple spatially adjacent views, or temporally adjacent pictures, or a combination of these. The depth image could alternatively or additionally be created from motion information, texture information or focus information.

In one embodiment, the second set of parameters are decoded from the bitstream and used to describe properties of the filter, properties of the input pictures to the filter, and/or properties of the output pictures from the filter and may be used as input to the NNPF.

The second set of parameters may include information on one or more of:
(1) The number of input views or input pictures;
(2) The view id for the view corresponding to the generated depth image;
(3) The nearest depth value, i.e., z near;
(4) The farthest depth value, i.e., z far;
(5) The minimum and maximum depth or disparity value of the depth image;
(6) Indication whether high values represent depth values near or far away and/or indication whether low values represent depth values near or far away;
(7) Indication whether the depth representation is uniform or non-linear. In case of non-linear information of the non-linearity representation and the mapping of depth.;
(8) The width and height of the depth image.

In one embodiment, the same or similar syntax and/or semantics are used for at least one parameter in the second set of parameters, as in the Depth representation SEI message in VSEI.

In one embodiment, decoding the second set of parameters are based on the indicator value indicating a purpose to generate a depth image, for at least one parameter in the second set of parameters.

Alternatively, the presence of at least one parameter in the second set of parameters in the bitstream depends on the indicator value indicating the purpose to generate a depth image.

### View Synthesis

In one embodiment, the purpose of the NN post-filter is to create additional spatially located views through view synthesis. The views could be synthesized by interpolating a new view between two or more input views or by extrapolating a view from one or more input views.

In one embodiment, the second set of parameters are decoded from the bitstream and used to describe properties of the filter, properties of the input pictures to the filter, and/or properties of the output pictures from the filter, and may be used as input to the NNPF. The second set of parameters may include information on one or more of:
(1) The input layers used for the view synthesis of the NNPF;
(2) The number of views to synthesize by the NNPF;
(3) Depth images as input to the view synthesis. These may be signaled or generated as part of a NNPF, see Depth image creation purpose above;
(4) The position of the one or more synthesized views, horizonal and/or vertical positions.

A version of this embodiment is illustrated with the syntax and semantics below, where the purpose_indicator equal to X, where X is a particular pre-defined value, indicates that the purpose of the NNPF is to synthesize one or more views. The input layer signaling is the same as in the layer information signaling example in embodiment 2. The number of intermediate output views that are synthesized by the NNPF between each pair of input views is indicated with a syntax element. The output views may be synthesized evenly between each pair of input views.

TABLE 25

| | Descriptor |
|---|---|
| purpose_indicator | u(16) |
| ... | |
| if (purpose_indicator == X ) { | |
| num_input_layers_minus1 | ue(v) |
| for ( i = 0; i <= num_input_layers_minus1; i++ ) | |
| input_layer_id [ i ] | ue(v) |
| input_view_id [ i ] | ue(v) |
| input_depth_layer_flag [ i ] | u(1) |
| if ( input_depth_layer_flag [ i ] ) | |
| input_associated_layer_id [ i ] | ue(v) |
| } | |
| num_input_views_minus1 | ue(v) |
| for ( i = 0; i < num_input_views_minus1; i++ ) | |
| num_intermediate_output_views [ i ] | ue(v) |
| } | |
| } | |
| ... | |
| } | |

num_input_views_minus1 plus 1 specifies the number of input views used as input to the NNPF.

num_intermediate_output_views[i] specifies the number of intermediate output views that are synthesized by the NNPF between the i-th and (i+1)-th input views.

In one embodiment, the same or similar syntax and/or semantics are used for at least one parameter in the second set of parameters, as in the Multiview view position SEI message and/or the Scalability dimension SEI message in VSEI.

In one embodiment, decoding the second set of parameters are based on the indicator value indicating a purpose to generate a view, for at least one parameter in the second set of parameters.

Alternatively, the presence of at least one parameter in the second set of parameters in the bitstream depends on the indicator value indicating the purpose to generate a view.

### Inpainting (Subtitle Removal, Object Removal, etc.)

In one embodiment, the purpose of the NN post-filter is to remove subtitles, advertisements, logos, and other objects or occlusions which are present in the picture but are desired to be removed from the picture. In one example of this embodiment, the NN post-filter may perform text detection and frame inpainting for the purpose of subtitle removal.

In one embodiment, the second set of parameters are decoded from the bitstream and used as input to the NN postfilter. The second set of parameters may include input parameters specifying which area of the picture the postfilter is going to be applied to. The input parameter may be a mask, coordinates of the area to be post-processed, an index referring to a set of location parameters in a list or an index referring to a predefined part of the picture.

In one embodiment, decoding the second set of parameters are based on the indicator value indicating a purpose as subtitle removal.

In one embodiment, the presence of at least one parameter in the second set of parameters in the bitstream depends on the indicator value indicating the purpose to remove subtitles.

One embodiment is illustrated with the syntax below, where the purpose_indicator equal to X, where X is a particular pre-defined value, indicates that the purpose of the NNPF is to perform subtitle removal on the current decoded picture.

TABLE 26

| | Descriptor |
|---|---|
| purpose_indicator | u(16) |
| ... | |
| if (purpose_indicator == X ) { | |
| location idx | ue(v) |
| } | |
| ... | |
| } | |

location_idx when present, indicates which part of the picture is input to the NNPF for subtitle removal purpose according to the following table. The value of location_idx shall be in the range of 0 to 3, inclusive.

TABLE 27

| location_idx value | Picture part |
|---|---|
| 0 | Lowest quarter of the picture |
| 1 | Lower half of the picture |
| 2 | All picture |
| 3 | Upper half of the picture |

A decoder may perform all or a subset of the following steps for this embodiment:

Step 1: Decode a coded picture from the bitstream (which may be referred to as the “current” picture) to produce a decoded picture (referred to below as the “current decoded picture”).

Step 2: Obtaining a first set of parameters specifying an NNPF (i.e., the first set of parameters comprises a set of NN parameters). Obtaining the first set parameters may comprise decoding at least some of the NN parameters from the bitstream and/or downloading at least some of the NN parameters from a server (e.g., an HTTP server). For example, obtaining the first set of parameters may comprise decoding a reference, e.g. URI, describing where the first set of parameters is located and then obtaining the parameters from that location. The NN parameters may also be obtained by external means, e.g., from local storage, pre-downloaded, etc.

Step 3: Decoding a first indicator value from a first syntax element in the bitstream and deriving from the first indicator value that the post-filter is a subtitle removal post-filter.

Step 4: Decoding a second value from a second syntax element in the bitstream and deriving a location description value indicating where the subtitle removal is applied on the current picture (and possible other pictures) from the second value.

Step 5: Apply the NN postfilter using the current decoded picture (and possible other decoded pictures) as input to the NN postfilter, to output at least one NN output picture from the NN postfilter. The location description value may additionally be used to derive the area of the current decoded picture (and the possible other decoded pictures) where the NN is applied.

One or more of the following two listed items may be combined with these steps:
(1) The first and second syntax element are present in at least one of a SEI message, parameter set, or header;
(2) The presence of the second syntax element depends on deriving that the post-filter is a deinterlacing post-filter, such that the second syntax element is only present in the bitstream and decoded from the bitstream if the post-filter is derived to be a subtitle removal post-filter.

### Focus and Blur

In one embodiment, the purpose of the NN post-filter is to adjust the focus or blur in the picture. This adjustment may be for artistic or narration reasons, for reducing the risk of motion sickness in a fast-moving content, for adapting content to a particular user or use case, smoothing coding artifacts, etc.

In one embodiment, the second set of parameters are decoded from the bitstream and used to describe properties of the filter, properties of the input pictures to the filter, and/or properties of the output pictures from the filter, and may be used as input to the NNPF.

The second set of parameters may include one or more of:
Input parameters specifying which area of the picture the postfilter is going to be applied to. The input parameter may be:
   A flag specifying if the postfiltering is applied to all the picture or not
   A mask, e.g. a mask that specifies a foreground and a background in a picture
   A depth value or a range that specify the parts of the picture to be post-processed.
   A set of coordinates that specify the area of the picture to be post-processed,
   An index referring to a set of location parameters in a list to specify a predefined part of the picture
A depth map or a depth image. This may for instance be the layer ID of the layer in the bitstream that carries the depth information
A disparity map. This may for instance be the layer ID of the layer in the bitstream that carries the disparity information.
Input parameters specifying a focus or blur strength
A depth value or range specifying the target focus plane for the picture
A position value in the picture that the depth value corresponding to that position specifies the target focus plane for the picture
An input parameter specifying the type of the focus/blur postfiltering. The type of the post-filtering may be:
   All in focus
   Partial stylistic focus
Motion vectors. This may be used for adding motion blur to the moving objects in the picture.
A threshold parameter to specify what is considered as fast and slow movement for the object(s) in the picture

In one embodiment, decoding the second set of parameters are based on the indicator value indicating a purpose as focus/blur adjustment.

This embodiment is illustrated with the syntax below, where the purpose_indicator equal to X, where X is a particular pre-defined value, indicates that the purpose of the NNPF is to adjust the focus/blur in the current decoded picture.

TABLE 28

| | Descriptor |
|---|---|
| purpose_indicator | u(16) |
| ... | |
| if (purpose_indicator == X ) { | |
| input_layer_id | ue(v) |
| } | |
| ... | |
| } | |

input_layer_id specifies the layer id of the input layer with depth information used by the NNPF.

Retexturing, restyling (or style transfer)

In one embodiment, the purpose of the NN post-filter is to retexture a picture, i.e., changing all or part of the texture of the picture, or similarly, restyle a picture i.e., changing all or part of the style of the picture using the post-processing NN.

In one embodiment, the second set of parameters are decoded from the bitstream and used to describe properties of the filter, properties of the input pictures to the filter, and/or properties of the output pictures from the filter, and may be used as input to the NNPF. The second set of parameters may include one or more of:
Information about the texture or style in the form of a texture or style template
Information about the texture or style in the form of high-level attribute(s) such as ‘striped’, ‘cracked’ or ‘veined’, or index of the attribute in a list of attributes.
Information about the texture or style in the form of the resolution or the grain size of the attribute.
Input parameter specifying whether the texture or style is applied to the luma or chroma channels (or both).
Input parameters specifying which area of the picture the postfilter is going to be applied to. The input parameter may be a mask, coordinates of the area to be post-processed or an index referring to a set of location parameters in a list.

In one embodiment, decoding the second set of parameters are based on the indicator value indicating a purpose to retexture or to restyle the picture.

Alternatively, the presence of at least one parameter in the second set of parameters in the bitstream depends on the indicator value indicating the purpose to retexture or restyling the picture.

This embodiment is illustrated with the syntax below, where the purpose_indicator equal to X, where X is a particular pre-defined value, indicates that the purpose of the NNPF is to retexture (or similarly to restyle) the associated current decoded picture.

TABLE 29

| | Descriptor |
|---|---|
| purpose_indicator | u(16) |
| ... | |
| if (purpose_indicator == X ) { | |
| attribute idx | u(2) |
| attribute_channel | u(3) |
| } | |
| ... | |
| } | |

attribute_idx when present, indicates which attribute is used as input for the NNPF to be applied to the picture according to the following table:

TABLE 30

| attribute_idx value | Attribute |
|---|---|
| 0 | Veined |
| 1 | Marbled |
| 2 | Cracked |
| 3 | Crystalline |

attribute_channel specifies which channels the post processing is applied to. The first bit corresponds to the luma channel and the second and third bit corresponds to the first and second chroma channels. A bit value equal to 1 specifies that the attribute is applied to the corresponding channel and a bit value equal to 0 specifies that the attribute is not applied to the corresponding channel.

### Film Grain Synthesis

In one embodiment, the purpose of the NN post-filter is to generate, or synthesize, film grain, or noise, for one or more output pictures from the NNPF.

In one embodiment, the second set of parameters are decoded from the bitstream and used to describe properties of the filter, properties of the one or more input pictures to the filter, and/or properties of the one or more output pictures from the filter and may be used as input to the NNPF. The second set of parameters may include information on one or more of:
A seed for generating the film grain
The number of input pictures
The number of output pictures
The colour primaries, transfer characteristics and/or matrix coefficients of the generated picture.
The bit depth for the output picture
The patch size of the generated film grain
The width and height of the generated picture
Type of grain pattern
Strength or intensity of the grains.

In one embodiment, the same or similar syntax and/or semantics are used for at least one parameter in the second set of parameters, as in the Film grain characteristics SEI message in VSEI.

In one embodiment, decoding the second set of parameters are based on the indicator value indicating a purpose to generate film grain, for at least one parameter in the second set of parameters.

Alternatively, the presence of at least one parameter in the second set of parameters in the bitstream depends on the indicator value indicating the purpose to generate film grain.

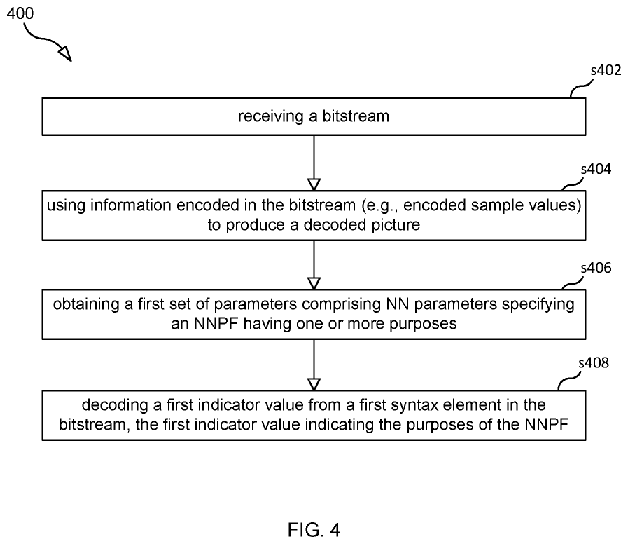

FIG. 4 is a flowchart illustrating a process 400 according to some embodiments which may be performed by device 103 (e.g., some or all of the steps may be performed by decoder 104). Process 400 may begin in step s402. Step s402 comprises receiving a bitstream.

Step s404 comprises using information encoded in the bitstream (e.g., encoded sample values) to produce the decoded picture.

Step s406 comprises obtaining a first set of parameters, the first set of parameters comprising neural network, NN, parameters specifying a NN post-filter, NNPF, having one or more purposes.

Step s408 comprise decoding a first indicator value from a first syntax element in the bitstream, the first indicator value indicating the purposes of the NNPF. The one or more purposes include: colour range conversion (including SDR to HDR conversion), deinterlacing, alpha map generation, depth image generation, generation of new views (view synthesis), inpainting (subtitle removal, object removal, etc), focus and blur, retexturing, restyling (or style transfer), and/or film grain synthesis.

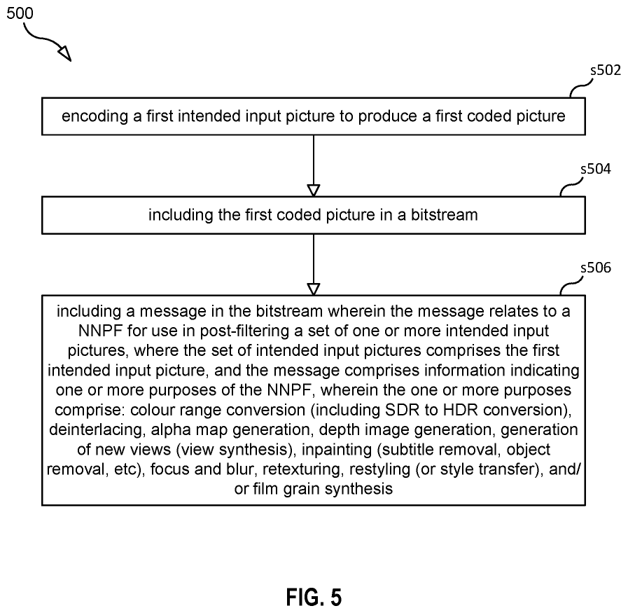

FIG. 5 is a flowchart illustrating a process 500, according to some embodiments which may be performed by encoder 102. Process 500 may begin in step s502.

Step s502 comprises encoding a first intended input picture to produce a first coded picture.

Step s504 comprises including the first coded picture in a bitstream.

Step s506 comprises including a message in the bitstream, wherein the message relates to a neural network, NN, post-filter, NNPF, for use in post-filtering a set of one or more intended input pictures, where the set of intended input pictures comprises the first intended input picture, and the message comprises information indicating one or more purposes of the NNPF, wherein the one or more purposes comprise: colour range conversion (including SDR to HDR conversion), deinterlacing, alpha map generation, depth image generation, generation of new views (view synthesis), inpainting (subtitle removal, object removal, etc), focus and blur, retexturing, restyling (or style transfer), and/or film grain synthesis.

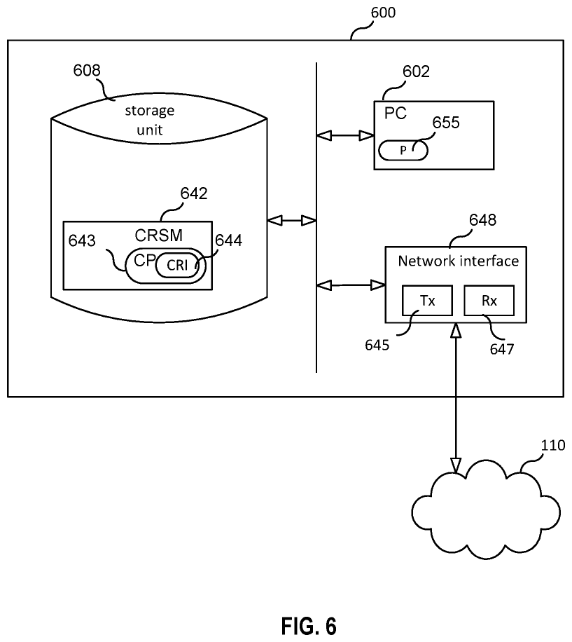

FIG. 6 is a block diagram of an apparatus 600 for implementing encoder 102 and/or receiving device 103, according to some embodiments. When apparatus 600 implements encoder 102, apparatus 600 may be referred to as an encoder apparatus, and when apparatus 600 implements receiving device 103, apparatus 600 may be referred to as a receiver apparatus. As shown in FIG. 6, apparatus 600 may comprise: processing circuitry (PC) 602, which may include one or more processors (P) 655 (e.g., one or more general purpose microprocessors and/or one or more other processors, such as an application specific integrated circuit (ASIC), field-programmable gate arrays (FPGAs), and the like), which processors may be co-located in a single housing or in a single data center or may be geographically distributed (i.e., apparatus 600 may be a distributed computing apparatus); at least one network interface 648 (e.g., a physical interface or air interface) comprising a transmitter (Tx) 645 and a receiver (Rx) 647 for enabling apparatus 600 to transmit data to and receive data from other nodes connected to a network 110 (e.g., an Internet Protocol (IP) network) to which network interface 648 is connected (physically or wirelessly) (e.g., network interface 648 may be coupled to an antenna arrangement comprising one or more antennas for enabling apparatus 600 to wirelessly transmit/receive data); and a storage unit (a.k.a., “data storage system”) 608, which may include one or more non-volatile storage devices and/or one or more volatile storage devices. In embodiments where PC 602 includes a programmable processor, a computer readable storage medium (CRSM) 642 may be provided. CRSM 642 may store a computer program (CP) 643 comprising computer readable instructions (CRI) 644. CRSM 642 may be a non-transitory computer readable medium, such as, magnetic media (e.g., a hard disk), optical media, memory devices (e.g., random access memory, flash memory), and the like. In some embodiments, the CRI 644 of computer program 643 is configured such that when executed by PC 602, the CRI causes apparatus 600 to perform steps described herein (e.g., steps described herein with reference to the flow charts). In other embodiments, apparatus 600 may be configured to perform steps described herein without the need for code. That is, for example, PC 602 may consist merely of one or more ASICs. Hence, the features of the embodiments described herein may be implemented in hardware and/or software.

### Summary of Various Embodiments

A1. A method for post-processing a decoded picture, the method comprising: receiving a bitstream; using information encoded in the bitstream (e.g., encoded sample values) to produce the decoded picture; obtaining a first set of parameters, the first set of parameters comprising neural network, NN, parameters specifying a NN post-filter, NNPF, having one or more purposes; and decoding a first indicator value from a first syntax element in the bitstream, the first indicator value indicating the purposes of the NNPF, wherein the one or more purposes comprise: colour range conversion (including SDR to HDR conversion), deinterlacing, alpha map generation, depth image generation, generation of new views (view synthesis), inpainting (subtitle removal, object removal, etc.), focus and blur, retexturing, restyling (or style transfer), and/or film grain synthesis.
A2. The method of the embodiment A1, further comprising: determining, based on the first indicator value, whether to post-process the decoded picture using the specified NNPF; and in response to determining to post-process the decoded picture using the NNPF, post-processing the decoded picture using the NNPF.
A3. The method of embodiment A1, further comprising decoding a second indicator value from a second syntax element in the bitstream; determining, based on the second indicator value, whether to post-process the decoded picture using the specified NNPF; and in response to determining to post-process the decoded picture using the NNPF, post-processing the decoded picture using the NNPF.
A3.1. The method of embodiment A3, wherein the second syntax element is signaled in a parameter set, a header, and/or an SEI message.
A4. The method of embodiment A1, further comprising post-processing the decoded picture using the specified NNPF.
A5. The method of any of embodiments A2-A4, wherein post-processing the decoded picture using the NNPF produces a post-processed decoded picture, text data, and/or audio data, and the method further comprises outputting the post-processed decoded picture, the text data, and/or the audio data.
A6. The method of any of the previous embodiments, wherein obtaining the first set of parameters comprises: decoding at least some of the parameters included in the first set of parameters from the bitstream; and/or decoding a reference indicating a device having access to at least some of the parameters included in the first set of parameters and obtaining the parameters from the device.
A7. The method of any of the previous embodiments, wherein the first syntax element is signaled in an SEI message, a parameter set, and/or a header.
A8. The method of any of the previous embodiments, further comprising decoding a second set of parameters from the bitstream, wherein the second set of parameters comprises information about: the input to the NNPF, the output from the NNPF, and/or other metadata for the NNPF.
A9. The method of embodiment A8, wherein the second set of parameters comprises information about: camera parameters, temporal identifier (e.g., time stamps, POCs or delta POCs), light condition, saturation level, contrast level, colour palette or colour look-up table, texture or style templates, attributes in the form of labels, seed value to produce random numbers, chroma phase parameters, aspect ratio, a text string describing the purpose, and/or layer id or layer information.
A10. The method of any of the previous embodiments, wherein a purpose of the NNPF is color range conversion (e.g., converting SDR to HDR), and the method further comprises obtaining color range conversion information comprising: i) information specifying colour primaries of a picture resulting from applying the NNPF, ii) information specifying transfer characteristics of the picture resulting from applying the NNPF, and/or iii) information specifying matrix coefficients of the picture resulting from applying the NNPF.
A10.1. The method of embodiment A10, further comprising, prior to obtaining the color range conversion information, determining that (V1 & X)≠0, where V1 is the first indicator value, X is a pre-defined value greater than 0, and & is the bitwise AND operator, wherein the color range conversion information is obtained as a result of determining that (V1 & X)≠0.
A11. The method of any of the previous embodiments, wherein a purpose of the NNPF is deinterlacing, and the method further comprises, as a result of determining that a purpose is deinterlacing, determining that the scan type of a picture resulting from applying the NNPF is in progressive format.
A12. The method of any of the previous embodiments, wherein a purpose of the NNPF is deinterlacing, and the method further comprises obtaining deinterlacing information comprising: information specifying a height of a picture resulting from applying the NNPF, information specifying a width of a picture resulting from applying the NNPF, information specifying a number of pictures that are produced as a result of applying the NNPF, and/or information specifying a temporal position of a picture resulting from applying the NNPF.
A13. The method of embodiment A12, wherein the step of obtaining the deinterlacing information is performed as a result of determining that the first indicator value indicates at least a deinterlacing purpose or a first purpose.
A14. The method of embodiment A13, wherein the step of obtaining the deinterlacing information is performed as a result of determining that: (V1 & (X1|X2))!=0, where V1 is the first indicator value, X1 is a first pre-defined value greater than 0 and associated with the first purpose, X2 is a second pre-defined value greater than 0 and associated with the deinterlacing purpose, & is the bitwise AND operator, and | is the bitwise OR operator.
B1. A method performed by an encoder apparatus, the method comprising: encoding a first intended input picture to produce a first coded picture; including the first coded picture in a bitstream; including a message in the bitstream, wherein the message relates to a neural network, NN, post-filter, NNPF, for use in post-filtering a set of one or more intended input pictures, where the set of intended input pictures comprises the first intended input picture, and the message comprises information indicating one or more purposes of the NNPF, wherein the one or more purposes comprise: colour range conversion (including SDR to HDR conversion), deinterlacing, alpha map generation, depth image generation, generation of new views (view synthesis), inpainting (subtitle removal, object removal, etc.), focus and blur, retexturing, restyling (or style transfer), and/or film grain synthesis.
B2. The method of embodiment B1, wherein the information indicating one or more purposes of the NNPF is a first syntax element encoding a first indicator value.
B3. The method of embodiment B2, wherein the first indicator value is a bitmask.
C1. A computer program (543) comprising instructions (544) which when executed by processing circuitry (502) of an apparatus (500) causes the apparatus to perform the method of any one of embodiments A1-A14 or B1-B3.
C2. A carrier containing the computer program of embodiment C1, wherein the carrier is one of an electronic signal, an optical signal, a radio signal, and a computer readable storage medium (542).
D1. An apparatus (500) that is configured to perform a method comprising: receiving a bitstream; using information encoded in the bitstream (e.g., encoded sample values) to produce the decoded picture; obtaining a first set of parameters, the first set of parameters comprising neural network, NN, parameters specifying a NN post-filter, NNPF, having one or more purposes; and decoding a first indicator value from a first syntax element in the bitstream, the first indicator value indicating the purposes of the NNPF, wherein the one or more purposes comprise: colour range conversion (including SDR to HDR conversion), deinterlacing, alpha map generation, depth image generation, generation of new views (view synthesis), inpainting (subtitle removal, object removal, etc.), focus and blur, retexturing, restyling (or style transfer), and/or film grain synthesis.
D2. The apparatus of embodiment D1, wherein the apparatus is further configured to perform the method of any one of embodiments A2-A14.
E1. An apparatus (500) that is configured to perform the method of any one of embodiments B1-B3.

### Additional Material

This additional material proposes the following modifications to the NN post-filter characteristics SEI message for the next version of VSEI:
(1) Adding a value to the nnpfc_purpose syntax element for a colour range conversion purpose (e.g. SDR to HDR conversion). When the colour range conversion purpose is indicated by nnpfc_purpose, the nnpfc_colour_primaries, nnpfc_transfer_characteristics and nnpfc_matrix_coeffs syntax elements are present in the SEI message. This replaces the nnpfc_separate_colour_description_present_flag;
(2) Adding a value to the nnpfc_purpose syntax element for a deinterlacing purpose. When the deinterlacing purpose is indicated by nnpfc_purpose, the nnpfc_pic_width_in_luma_samples, nnpfc_pic_height_in_luma_samples, nnpfc_interpolated_pics[ i], and nnpfc_input_pic_output_flag[i] are present in the SEI message;
(3) Restructure the semantics of nnpfc_purpose with the definition of the nnpfc_purpose.

The proposed purposes bring support for well-established use cases with only minor text additions to the current draft.

### Introduction

The draft of VSEI version 3 includes a new neural-network post-filter characteristics (NNPFC) SEI message that specifies a neural network that may be used as a post-processing filter. The purpose of the neural network is indicated with the nnpfc_purpose syntax element that currently supports the following purposes: general visual quality improvement; chroma upsampling; resolution upsampling; picture rate upsampling; bit depth upsampling; colourization.

The parts of the syntax and semantics that are relevant for this additional material is shown in the table below.

TABLE 31

| nn_post_filter_characteristics( payloadSize ) { | Descriptor |
|---|---|
| nnpfc_purpose | u(16) |
| ... | |
| nnpfc_property_present_flag | u(1) |
| if( nnpfc_property_present_flag ) { | |
| ... | |
| nnpfc_num_input_pics_minus1 | ue(v) |
| ... | |
| if( ( nnpfc_purpose & 0x04 ) != 0 ) { | |
| nnpfc_pic_width_in_luma_samples | ue(v) |
| nnpfc_pic_height_in_luma_samples | ue(v) |
| } | |
| if( ( nnpfc_purpose & 0x08 ) != 0 ) { | |
| for( i = 0; i < nnpfc_num_input_pics_minus1; i++ ) | |
| nnpfc_interpolated_pics[ i ] | ue(v) |
| for( i = 0; i <= nnpfc_num_input_pics_minus1; i++ ) | |
| nnpfc_input_pic_output_flag[ i ] | u(1) |
| } | |
| ... | u(1) |
| nnpfc_separate_colour_description_present_flag | u(1) |
| if( nnpfc_separate_colour_description_present_flag ) { | |
| nnpfc_colour_primaries | u(8) |
| nnpfc_transfer_characteristics | u(8) |
| nnpfc_matrix_coeffs | u(8) |
| } | |
| ... | |
| } | |
| ... | |
| } | |

nnpfc_purpose indicates the purpose of the NNPF as specified in Table 32.

The value of nnpfc_purpose shall be in the range of 0 to 63, inclusive, in bitstreams conforming to this edition of this document. Values of 64 to 65535, inclusive, for nnpfc_purpose are reserved for future use by ITU-T|ISO/IEC and shall not be present in bitstreams conforming to this edition of this document. Decoders conforming to this edition of this document shall ignore NNPFC SEI messages with nnpfc_purpose in the range of 64 to 65535, inclusive.

TABLE 32
Definition of nnpfc_purpose

| Value | Interpretation |
|---|---|
| nnpfc_purpose = = 0 | May be used as determined by the application |
| nnpfc_purpose > 0 && | No general visual quality improvement |
| ( nnpfc_purpose & | |
| 0x01 ) = = 0 | |
| ( nnpfc_purpose & | With general visual quality improvement |
| 0x01 ) != 0 | |
| nnpfc_purpose > 0 && | No chroma upsampling (from the 4:2:0 chroma format to the 4:2:2 |
| ( nnpfc_purpose & | or 4:4:4 chroma format, or from the 4:2:2 chroma format to the |
| 0x02 ) = = 0 | 4:4:4 chroma format) |
| ( nnpfc_purpose & | With chroma upsampling |
| 0x02 ) != 0 | |
| nnpfc_purpose > 0 && | No resolution upsampling (increasing the width or height) |
| ( nnpfc_purpose & | |
| 0x04 ) = = 0 | |
| ( nnpfc_purpose & | With resolution upsampling |
| 0x04 ) != 0 | |
| nnpfc_purpose > 0 && | No picture rate upsampling |
| ( nnpfc_purpose & | |
| 0x08 ) = = 0 | |
| ( nnpfc_purpose & | With picture rate upsampling |
| 0x08 ) != 0 | |
| nnpfc_purpose > 0 && | No bit depth upsampling (increasing the luma bit depth or the |
| ( nnpfc_purpose & | chroma bit depth) |
| 0x10 ) = = 0 | |
| ( nnpfc_purpose & | With bit depth upsampling |
| 0x10 ) != 0 | |
| nnpfc_purpose > 0 && | No colourization (from the 4:0:0 chroma format to the 4:2:0, 4:2:2, |
| ( nnpfc_purpose & | or 4:4:4 chroma format) |
| 0x20 ) = = 0 | |
| ( nnpfc_purpose & | With colourization |
| 0x20 ) != 0 | |

When a reserved value of nnpfc_purpose is taken into use in the future by ITU-T|ISO/IEC, the syntax of this SEI message could be extended with syntax elements whose presence is conditioned by nnpfc_purpose being equal to that value.

When ChromaFormatIdc is equal to 3, nnpfc_purpose & 0x02 shall be equal to 0.

When ChromaFormatIdc or nnpfc_purpose & 0x02 is not equal to 0, nnpfc_purpose & 0x20 shall be equal to 0.

### Separate Colour Description in the NNPFC SEI Message

The NNPFC SEI message includes a nnpfc_separate_colour_description_present_flag. When this flag is equal to 1, syntax elements indicating the colour primaries, transfer characteristics and matrix coefficients of the resulting output picture from the NN post-filter are signaled in the SEI message. When the flag is equal to 0, no additional syntax elements are signaled and the output picture from the NN post-filter is indicated to have the same colour primaries, transfer characteristics, and matrix coefficients as the input picture as defined in the VUI.

### Interlacing and Deinterlacing

VVC supports interlaced video by signaling the source scan type of the pictures in the VUI. In addition, the frame-field information SEI message in VSEI may be used to indicate how the associated picture is intended to be displayed, the source scan type of the associated picture, and whether the associated picture is a duplicate of a previous picture, in output order, of the same layer.

The process of converting from interlaced format to progressive format is referred to as deinterlacing.

### Problem Statement

The NNPFC SEI message does not include purposes for colour range conversion or deinterlacing. These are well-established use cases for NN post-filtering and that it would be beneficial to include both as purposes using the nnpfc_purpose syntax element of the NNPFC SEI message.

Although the nnpfc_separate_colour_description_present_flag equal to 1 provides the syntax elements needed for converting the colour primaries, transfer characteristics and matrix coefficients, there is no purpose indicated for it. Colour range conversion from SDR to HDR is expected to be an important use case for the NN post-filter SEI message and it would be beneficial to see a specific purpose for it. An advantage of signaling the colour range conversion purpose in the nnpfc_purpose syntax element, is that it becomes exposed as a purpose and is easily accessible in the first syntax element of the SEI message. Also, using the nnpfc_purpose syntax element rather than a separate flag would make the design more consistent.

In addition, the semantics of the nnpfc_purpose syntax element would benefit from a restructuring to improve the readability, in particular if more purposes are being added.

### Proposal

### NNPFC Purpose for Colour Range Conversion

It is proposed to add a value to the nnpfc_purpose syntax element for a colour range conversion purpose (e.g. SDR to HDR conversion). When the colour range conversion purpose is indicated by nnpfc_purpose, the nnpfc_colour_primaries, nnpfc_transfer_characteristics and nnpfc_matrix_coeffs syntax elements are present in the SEI message. This replaces the nnpfc_separate_colour_description_present_flag.

### Proposed Syntax and Semantics

Proposed changes to syntax and semantics are marked with italics for added text and with [[ ]] for removed text.

TABLE 33

| nn_post_filter_characteristics( payloadSize ) { | Descriptor |
|---|---|
| nnpfc_purpose | u(16) |
| ... | |
| nnpfc_property_present_flag | u(1) |
| if( nnpfc_property_present_flag ) { | |
| ... | |
| nnpfc_inp_order_idc | ue(v) |
| nnpfc_auxiliary_inp_idc | ue(v) |
| if (nnpfc_purpose & 0x30 != 0 ) { | |
| [[nnpfc_separate_colour_description_present_flag]] | u(1) |
| [[if( nnpfc_separate_colour_description_present_flag ) {]] | |
| nnpfc_colour_primaries | u(8) |
| nnpfc_transfer_characteristics | u(8) |
| nnpfc_matrix_coeffs | u(8) |
| } | |
| ... | |
| } | |
| ... | |
| } | |

TABLE 34
Definition of nnpfc_purpose

| Value | Interpretation |
|---|---|
| nnpfc_purpose = = 0 | May be used as determined by the application |
| nnpfc_purpose > 0 && | No general visual quality improvement |
| ( nnpfc_purpose & | |
| 0x01 ) = = 0 | |
| ( nnpfc_purpose & | With general visual quality improvement |
| 0x01 ) != 0 | |
| . . . | |
| nnpfc purpose > 0 && | No colour range conversion (e.g., from SDR |
| ( nnpfc purpose & | to HDR) |
| 0x30 ) = = 0 | |
| ( nnpfc purpose & | With colour range conversion |
| 0x30 ) != 0 | |

### NNPFC Purpose for Deinterlacing

It is proposed to add a value to the nnpfc_purpose syntax element for a deinterlacing purpose. When the deinterlacing purpose is indicated by nnpfc_purpose, the nnpfc_pic_width_in_luma_samples, nnpfc_pic_height_in_luma_samples, nnpfc_interpolated_pics[ i], and nnpfc_input_pic_output_flag[i] syntax elements are present in the SEI message.

Changing the height by a factor of two for the output pictures compared to the decoded input pictures may be necessary when the decoded pictures are fields and changing the number of output pictures compared to the number of decoded input pictures may be useful to support interlaced full picture format and 3:2 pull down. To support the conversion from 1080i to 720p it is also necessary to allow for a smaller width and height of the output picture compared to the input picture.

### Proposed Syntax and Semantics

Proposed changes to syntax and semantics are marked with italics for added text and removed text with [[ ]].

TABLE 35

| nn_post_filter_characteristics( payloadSize ) { | Descriptor |
|---|---|
| nnpfc_purpose | u(16) |
| ... | |
| nnpfc_property_present_flag | u(1) |
| if( nnpfc_property_present_flag ) { | |
| ... | |
| if( ( nnpfc_purpose & 0x20 ) != 0 ) | |
| nnpfc_out_colour_format_idc | u(2) |
| if( ( nnpfc_purpose & ( (0x04 \| 0x40) ) != 0 ) { | |
| nnpfc_pic_width_in_luma_samples | ue(v) |
| nnpfc_pic_height_in_luma_samples | ue(v) |
| } | |
| if( ( nnpfc_purpose & (0x08 \| 0x40) ) != 0 ) { | |
| for( i = 0; i < nnpfc_num_input_pics_minus1; i++ ) | |
| nnpfc_interpolated_pics[ i ] | ue(v) |
| for( i = 0; i <= nnpfc_num_input_pics_minus1; i++ ) | |
| nnpfc_input_pic_output_flag[ i ] | u(1) |
| } | |
| ... | |
| } | |
| ... | |
| } | |

TABLE 36
Definition of nnpfc_purpose

| Value | Interpretation |
|---|---|
| nnpfc_purpose = = 0 | May be used as determined by the application |
| nnpfc_purpose > 0 && | No general visual quality improvement |
| ( nnpfc_purpose & | |
| 0x01 ) = = 0 | |
| ( nnpfc_purpose & | With general visual quality improvement |
| 0x01 ) != 0 | |
| . . . | |
| nnpfc_{—}purpose > 0 && | No deinterlacing |
| ( nnpfc_{—}purpose & | |
| 0x40 ) = = 0 | |
| ( nnpfc_{—}purpose & | With deinterlacing |
| 0x40 ) != 0 | |

nnpfc_pic_width_in_luma_samples and nnpfc_pic_height_in_luma_samples specify the width and height, respectively, of the luma sample array of the picture resulting from applying the NNPF identified by nnpfc_id to a cropped decoded output picture. When nnpfc_pic_width_in_luma_samples and nnpfc_pic_height_in_luma_samples are not present, they are inferred to be equal to CroppedWidth and CroppedHeight, respectively. When nnpfc_purpose & 0x40 is not equal to 0, the value of nnpfc_pic_width_in_luma_samples shall be in the range of CroppedWidth/2 to CroppedWidth*16-1, inclusive, and the value of nnpfc_pic_height_in_luma_samples shall be in the range of CroppedHeight/2 to CroppedHeight*16-1, inclusive, otherwise, the value of nnpfc_pic_width_in_luma_samples shall be in the range of CroppedWidth to CroppedWidth*16-1, inclusive, and the value of nnpfc_pic_height_in_luma_samples shall be in the range of CroppedHeight to CroppedHeight*16-1, inclusive.

nnpfc_input_pic_output_flag[i] equal to 1 indicates that for the i-th input picture the NNPF generates a corresponding output picture. nnpfc_input_pic_output_flag[i] equal to 0 indicates that for the i-th input picture the NNPF does not generate a corresponding output picture.

The variables numInputPics, specifying the number of pictures used as input for the NNPF, and numOutputPics, specifying the total number of pictures resulting from the NNPF, are derived as shown in the table below:

TABLE 37

```
numInputPics = nnpfc_num_input_pics_minus1 + 1
if( ( nnpfc_purpose & (0x08 | 0x40) ) != 0 ) {
    for( i = 0, numOutputPics = 0; i < numInputPics; i++ )
      if( nnpfc_input_pic_output_flag[ i ] )
          numOutputPics++
    for( i = 0; i <= numInputPics − 2; i++ )
      (76)
      numOutputPics += nnpfc_interpolated_pics[ i ]
} else
    numOutputPics = 1
```

### Restructure of Nnpfc_Purpose Semantics (Editorial)

The current version of the table showing the semantics for the nnpfc_purpose syntax element would benefit from a restructuring to improve readability, in particular if more purposes are being added to the list of purposes. Therefore it is proposed to simplify the table and the corresponding semantics.

### Proposed Syntax and Semantics

Proposed changes to syntax and semantics are marked with italics for added text and with [[ ]] for removed text.

nnpfc_purpose indicates the purpose of the NNPF, where (nnpfc_purpose & bitmask) not equal to 0 indicates that the purpose associated with the bitmask value is indicated. nnpfc_purpose>0 and (nnpfc_purpose & bitmask) equal to 0 indicates that a purpose is not indicated. When nnpfc_purpose is equal to 0, the NNPF may be used as determined by the application.

The value of nnpfc_purpose shall be in the range of 0 to 63, inclusive, in bitstreams conforming to this edition of this document. Values of 64 to 65 535, inclusive, for nnpfc_purpose are reserved for future use by ITU-T|ISO/IEC and shall not be present in bitstreams conforming to this edition of this document. Decoders conforming to this edition of this document shall ignore NNPFC SEI messages with nnpfc_purpose in the range of 64 to 65 535, inclusive.

TABLE 38

| Bitmask | Interpretation |
|---|---|
| 0x01 | General visual quality improvement |
| 0x02 | Chroma upsampling (from the 4:2:0 chroma format to the 4:2:2 or 4:4:4 |
| | chroma format, or from the 4:2:2 chroma format to the 4:4:4 chroma format) |
| 0x04 | Resolution upsampling (increasing the width or height) |
| 0x08 | Picture rate upsampling |
| 0x10 | Bit depth upsampling (increasing the luma bit depth or the chroma bit depth) |
| 0x20 | Colourization (from the 4:0:0 chroma format to the 4:2:0, 4:2:2, or 4:4:4 |
| | chroma format) |
| 0x30 | Colour range conversion (e.g., from SDR to HDR) |
| 0x40 | Deinterlacing |

When a reserved value of nnpfc_purpose is taken into use in the future by ITU-T|ISO/IEC, the syntax of this SEI message could be extended with syntax elements whose presence is conditioned by nnpfc_purpose being equal to that value.

When ChromaFormatIdc is equal to 3, nnpfc_purpose & 0x02 shall be equal to 0.

When ChromaFormatIdc or nnpfc_purpose & 0x02 is not equal to 0, nnpfc_purpose & 0x20 shall be equal to 0.

While the terminology in this disclosure is described in terms of VVC, the embodiments of this disclosure also apply to any existing or future codec, which may use a different, but equivalent terminology. Also, the word “a” is intended to be interpreted broadly to mean “one or more” or “at least one,” unless indicated otherwise.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method for post-processing a decoded picture, the method comprising:
receiving a bitstream;
using information encoded in the bitstream to produce the decoded picture;
obtaining a first set of parameters, the first set of parameters comprising neural network (NN) parameters specifying a NN post-filter (NNPF) having one or more purposes; and
decoding a first indicator value from a first syntax element in the bitstream, the first indicator value indicating the purposes of the NNPF, wherein the one or more purposes comprise:
colour range conversion,
deinterlacing,
alpha map generation,
depth image generation,
generation of new views,
inpainting,
focus and blur,
retexturing,
restyling,
style transfer, and/or
film grain synthesis.

2. The method of the claim 1, wherein
the method further comprises:
determining, based on the first indicator value, whether to post-process the decoded picture using the specified NNPF; and
in response to determining to post-process the decoded picture using the NNPF, post-processing the decoded picture using the NNPF.

3. The method of claim 1, wherein
the method further comprises:
decoding a second indicator value from a second syntax element in the bitstream;
determining, based on the second indicator value, whether to post-process the decoded picture using the specified NNPF; and
in response to determining to post-process the decoded picture using the NNPF, post-processing the decoded picture using the NNPF.

4. The method of claim 3, wherein
the second syntax element is signaled in a parameter set, a header, or a supplemental enhancement information (SEI) message.

5. The method of claim 1, wherein the method further comprises post-processing the decoded picture using the specified NNPF.

6. The method of claim 2, wherein
post-processing the decoded picture using the NNPF produces a post-processed decoded picture, text data, and/or audio data, and
the method further comprises outputting the post-processed decoded picture, the text data, and/or the audio data.

7. The method of claim 1, wherein
obtaining the first set of parameters comprises:
decoding at least some of the parameters included in the first set of parameters from the bitstream; and/or
decoding a reference indicating a device having access to at least some of the parameters included in the first set of parameters and obtaining the parameters from the device.

8. The method of claim 1, wherein
the first syntax element is signaled in a supplemental message, a parameter set, and/or a header.

9. The method of claim 1, wherein
the method further comprises decoding a second set of parameters from the bitstream, wherein the second set of parameters comprises information about:
the input to the NNPF,
the output from the NNPF, and/or
other metadata for the NNPF.

10. The method of claim 9, wherein
the second set of parameters comprises:
camera parameters,
a temporal identifier,
light condition information,
saturation level information,
contrast level information,
colour palette or colour look-up table information,
texture or style templates,
attributes in the form of labels,
seed value information to produce random numbers,
chroma phase parameters,
aspect ratio information,
a text string describing the purpose, and/or
layer id or layer information.

11. The method of claim 9, wherein
the second set of parameters comprises information used for post-processing the decoded picture with the NNPF for: colour range conversion, deinterlacing, alpha map generation, depth image generation, generation of new views, inpainting, focus and blur, retexturing, restyling, style transfer, and/or film grain synthesis.

12. The method of claim 1, wherein
a purpose of the NNPF is color range conversion, and
the method further comprises obtaining color range conversion information comprising: i) information specifying colour primaries of a picture resulting from applying the NNPF, ii) information specifying transfer characteristics of the picture resulting from applying the NNPF, and/or iii) information specifying matrix coefficients of the picture resulting from applying the NNPF.

13. The method of claim 12, wherein
the method further comprises, prior to obtaining the color range conversion information, determining that (V1 & X)≠0,
V1 is the first indicator value,
X is a pre-defined value greater than 0,
& is the bitwise AND operator, and
the color range conversion information is obtained as a result of determining that (V1 & X)≠0.

14. The method of claim 1, wherein
a purpose of the NNPF is deinterlacing, and
the method further comprises, as a result of determining that a purpose is deinterlacing:
determining that the scan type of a picture resulting from applying the NNPF is in progressive format; and/or
obtaining deinterlacing information comprising:
information specifying a height of a picture resulting from applying the NNPF,
information specifying a width of a picture resulting from applying the NNPF,
information specifying a number of pictures that are produced as a result of applying the NNPF, and/or
information specifying a temporal position of a picture resulting from applying the NNPF.

15. (canceled)

16. The method of claim 14, wherein
the step of obtaining the deinterlacing information is performed as a result of determining that the first indicator value indicates at least a deinterlacing purpose or a first purpose, and/or
the step of obtaining the deinterlacing information is performed as a result of determining that:
(V1 & (X1|X2))!=0, where
V1 is the first indicator value,
X1 is a first pre-defined value greater than 0 and associated with the first purpose,
X2 is a second pre-defined value greater than 0 and associated with the deinterlacing purpose,
& is the bitwise AND operator, and

| is the bitwise OR operator.

17. (canceled)

18. A method performed by an encoder apparatus, the method comprising:
encoding a first intended input picture to produce a first coded picture;
including the first coded picture in a bitstream; and
including a message in the bitstream, wherein
the message relates to a neural network (NN) post-filter (NNPF) for use in post-filtering a set of one or more intended input pictures, where the set of intended input pictures comprises the first intended input picture, and
the message comprises information indicating one or more purposes of the NNPF, wherein the one or more purposes comprise:
colour range conversion,
deinterlacing,
alpha map generation,
depth image generation,
generation of new views,
inpainting,
focus and blur,
retexturing,
restyling,
style transfer, and/or
film grain synthesis.

19-20. (canceled)

21. A non-transitory computer readable storage medium storing a computer program comprising instructions which when executed by processing circuitry of an apparatus causes the apparatus to perform the method of claim 1.

22. (canceled)

23. An apparatus that is configured to perform a method comprising:
receiving a bitstream;
using information encoded in the bitstream to produce the decoded picture;
obtaining a first set of parameters, the first set of parameters comprising neural network (NN) parameters specifying a NN post-filter (NNPF) having one or more purposes; and
decoding a first indicator value from a first syntax element in the bitstream, the first indicator value indicating the purposes of the NNPF, wherein the one or more purposes comprise:
colour range conversion,
deinterlacing,
alpha map generation,
depth image generation,
generation of new views,
inpainting,
focus and blur,
retexturing,
restyling,
style transfer, and/or
film grain synthesis.

24. (canceled)

25. An apparatus that is configured to perform a method comprising:
encoding a first intended input picture to produce a first coded picture;
including the first coded picture in a bitstream; and
including a message in the bitstream, wherein
the message relates to a neural network (NN) post-filter (NNPF) for use in post-filtering a set of one or more intended input pictures, where the set of intended input pictures comprises the first intended input picture, and
the message comprises information indicating one or more purposes of the NNPF, wherein the one or more purposes comprise:
colour range conversion,
deinterlacing,
alpha map generation,
depth image generation,
generation of new views,
inpainting,
focus and blur,
retexturing,
restyling,
style transfer, and/or
film grain synthesis.

26-27. (canceled)
